(19) United States
(12) Patent Application Publication
(10) Pub. No.: US 2022/0027637 A1
(43) Pub. Date: Jan. 27, 2022

(54) PROPERTY MONITORING AND MANAGEMENT USING A DRONE

(71) Applicant: Alarm.com Incorporated, Tysons, VA (US)

(72) Inventors: Donald Gerard Madden, Columbia, MD (US); Ethan Shayne, Clifton Park, NY (US); Babak Rezvani, Tysons, VA (US); Ahmad Seyfi, Tysons, VA (US); Glenn Tournier, Vienna, VA (US)

(21) Appl. No.: 17/381,611

(22) Filed: Jul. 21, 2021

Related U.S. Application Data
(60) Provisional application No. 63/054,486, filed on Jul. 21, 2020.

(51) Int. Cl. G06K 9/00; G08B 13/196; G05D 1/12; B64C 39/02; H04W 4/40

(52) U.S. Cl. CPC G06K 9/00771; G06K 9/00637; G08B 13/19608; G08B 13/19645; B64C 2201/127; B64C 39/024; H04W 4/40; G06K 2209/21; G05D 1/12

(57) ABSTRACT

Methods, systems, and apparatus, including computer programs encoded on computer-storage media, for property management and monitoring using a drone. In some implementations, images of an outside area corresponding to a property are obtained. From the images, it is determined that a person is approaching the property. A state of the property is identified. An action to perform by a drone is determined based on the images and a state of the property. The drone is instructed to navigate to the person and perform the action.

### CROSS-REFERENCE TO RELATED APPLICATION

This application claims the benefit of U.S. Provisional Application No. 63/054,486, filed Jul. 21, 2020, and titled “PROPERTY MONITORING AND MANAGEMENT USING A DRONE,” which is incorporated by reference in its entirety.

### TECHNICAL FIELD

The present specification relates to security systems.

### BACKGROUND

Doorbell cameras can be helpful for detecting package delivery or theft, recognizing visitors, and allowing for remote communication with anyone near the doorbell. However, a camera in a fixed location has only a limited field of view.

### SUMMARY

In some implementations, a system may use images from a doorbell camera to determine events or conditions that are occurring at a property, and/or to confirm that expected events or conditions are occurring at the property. For example, the images of the doorbell camera can indicate various events and/or conditions at the property, such as that a person is approaching the property, that a person is located on the front porch of a property, that a person is carrying a package, that a person has dropped off a package, that the facial features of a person approaching and/or near the property match a known person, that the facial features of a person approaching and/or near the property do not match any known persons, that a person has taken a package from the property, etc. These events and/or conditions can serve as factors for the system in determining one or more actions to be performed. The system can also take into consideration other factors, such as scheduled events, the time associated with an event and/or condition, the location of occupants of the property, etc., in determining the one or more actions to be performed.

In some implementations, the actions performed by the system can include providing instructions to a drone to perform one or more actions. For example, the system may wirelessly send instructions to a drone to monitor and/or greet a person approaching, near, or leaving the property. As another example, the system may instruct the drone to open a line of communication between the person and an occupant of the property, or to open a line of communication between the person and an occupant of the property depending on the actions of the person. Similarly, the drone may approach the occupant and guide them to or notify them of a visitor.

In some implementations, the actions performed by a drone and/or the instructions provided to the drone are dynamic in that the actions may depend on the reactions of one or more persons. For example, a drone may attempt to open a line of communication between a person approaching the property and an occupant of the property if it determines that the occupant is not home and/or if it determines that the person wants to speak to the occupant.

In some implementations, the system may use the images from the doorbell camera to determine one or more events and/or conditions at the property. For example, the system may use a set of images from the doorbell camera to determine one or more of that a person near the property is recognized as a friend, that a person near the property is recognized as an occupant of the property, that a person near the property is recognized as a family member of an occupant of the property, that a person near the property is unknown, that the person is approaching the property, that the person is approaching the property with a package, that the person has dropped off a package at the property, that the person is located at a specific location on the property such as a front porch of the property, that the person has taken a package from the property, etc. In attempting to recognize the person using the images from the doorbell camera, the system may refer to one or more stored images of known persons, such as stored images of friends, occupants of the property, and/or family members. The system can compare one or more stored images (or data retrieved from the stored images) with the image(s) obtained from the doorbell camera (or data retrieved from the image(s) obtained from the doorbell camera).

In some implementations, the system may collect sensor data and use the sensor data to determine if a visitor of the property and an occupant of a property are already interacting with one another. The sensor data may include, for example, image data and audio data. The system may use the image data to determine if the visitor and the occupant are near one another. Similarly, the system may use the audio data to determine if the visitor and the occupant are talking to one another. The actions performed by the system may be dependent upon the determination that the visitor and occupant are interacting with one another. For example, instead of having a drone notify the occupant of the visitor's arrival and/or greet the visitor, the system may instead have the drone monitor the visitor if it determines that the visitor and occupant are already interacting.

In some implementations, the system may use other factors in determining one or more actions to perform. These other factors can include for example, a determination that the occupant(s) of the property is/are currently at home, a determination that the occupant(s) of the property is/are located in the backyard of the property, a time corresponding to a detected event/condition (e.g., higher chance that an unknown person near the property will commit a crime at night due to a lower chance that the person is there as a guest or is there to provide a service and/or a delivery), or a time corresponding to a scheduled event/condition (e.g., a known package delivery time or range of times, a time or range of times of a scheduled service, an expected arrival time or range of times of a person such as a visitor, etc.).

In one general aspect, a method includes: obtaining, using one or more imaging devices, images of an outside area corresponding to a property, where the images are captured by one or more cameras (i) of the one or more imaging devices or (ii) electronically connected to the one or more imaging devices; determining, from the images, that a person is approaching the property or has entered the property; identifying a state of the property; based on the images and the state of the property, determining an action to perform by a drone; and instructing the drone to: navigate to a location corresponding to the person; and perform the action.

Implementations include one or more of the following features. For example, in some implementations, identifying the state of the property includes determining whether any occupants of the property are located at the property, where determining the action to perform by the drone includes determining the action based on whether any occupants of the property are located at the property.

In some implementations, determining whether any occupants of the property are located at the property includes determining that one or more occupants of the property are located at the property; identifying the state of the property includes determining one or more locations of the one or more occupants at the property; and determining the action to perform by the drone includes determining the action based on the one or more locations of the one or more occupants.

In some implementations, determining the action based on the one or more locations of the one or more occupants includes: based on the one or more locations of the one or more occupants, selecting a location of the one or more locations corresponding to an occupant of the one or more occupants; and determining that the drone is to guide the person to the location of the occupant.

In some implementations, determining that the drone is to guide the person to the location of the occupant includes determining that drone is to guide the person instead of performing one or more other actions in response to at least one of the following: based on the images, identifying the person as a previously identified person; based on the images, identifying the person as a visitor of the property; determining that the one or more occupants of the property include an adult occupant and that the occupant is an adult occupant; determining that the location of the occupant is a location in a particular area of the property where permission settings for the property indicate that at least one person is permitted to approach or enter the particular area of the property; and determining that a current time coincides with a set time range (i) for a scheduled event, (ii) when control settings provide that at least one person is permitted to approach or enter the property, or (iii) between sunrise and sunset of a geographic location of the property.

In some implementations, the one or more other actions include at least one of the following: tracking the person using an onboard camera of the drone while the person approaches the property or remains on the property; opening a line of communication between the drone and a device of the occupant; and generating and wirelessly transmitting a notification to a device of the occupant or to an external computing system.

In some implementations, determining whether any occupants of the property are located at the property includes determining that one or more occupants of the property are located at the property; identifying the state of the property includes determining one or more identities of the one or more occupants; and determining the action to perform by the drone includes determining the action based on the one or more identities of the one or more occupants.

In some implementations, determining the action based on the one or more identities of the one or more occupants includes: based on the one or more identities, selecting an occupant of the one or more occupants located at the property; and determining that the drone is to guide the person to the location of the occupant based on the identity of the occupant.

In some implementations, selecting the occupant of the one or more occupants located at the property includes selecting the occupant from the one or more occupants based on at least one of the following: the occupant of the one or more occupants is an adult where at least one other occupant of the one or more occupants is a child; the occupant of the one or more occupants is permanent occupant of the property where at least one other occupant of the one or more occupants is a temporary occupant; and control settings indicates that the occupant of the one or more occupants is preferred to make contact with the person or with all persons over at least one other occupant of the one or more occupants.

In some implementations, identifying the state of the property includes determining a time or date, where determining the action to perform by the drone includes determining the action based on the time or date.

In some implementations, determining the action based on the time or date includes determining that the drone is to: track the person; generate a notification if the person enters the property or remains on the property; and wirelessly transmit the notification to at least one occupant of the property or an external system.

In some implementations, determining that the drone is to track the person includes: based on the images, determining that the person is not an occupant of the property; and determining to track the person in response to a determination that (i) a current time or date corresponds to a set time or date when visitors are not permitted to enter the property or (ii) the current time or date does not intersect one or more time ranges when visitors are permitted to enter the property.

In some implementations, determining the action includes determining to communicate with the person by the drone using communication parameters selected based on at least one of the state of the property and the images; and instructing the drone to perform the action includes instructing the drone to communicate with the person using the communication parameters.

In some implementations, identifying the state of the property includes using the images to determine an identity of the person; and determining the action to perform by the drone includes determining an action to perform by the drone based on the identity of the person.

In some implementations, identifying the state of the property includes using the images to determine that the person is a newly identified person; and determining the action to perform by the drone includes determining instructions to have the drone track the person until they leave the property or change trajectory so that their new trajectory does not intersect at least a portion of the property.

In some implementations, the one or more imaging devices comprise a smart doorbell installed on the property at a position having a viewpoint of the outside area; the one or more cameras comprise a doorbell camera (i) of the smart doorbell or (ii) electronically connected to the smart doorbell; and obtaining the images includes using the doorbell camera to capture at least a subset of the images of the outside area.

In some implementations, obtaining the images includes: based on the state of the property, determining one or more triggering events; detecting a triggering event of the one or more triggering events; and in response to detecting the triggering event, obtaining the images using the one or more imaging devices.

In some implementations, obtaining the images includes: based on the state of the property, activating the one or more imaging devices; and after activating the one or more imaging devices, obtaining the images using the one or more imaging devices.

Other embodiments of these aspects include corresponding systems, apparatus, and computer programs encoded on computer storage devices, configured to perform the actions of the methods. A system of one or more computers can be so configured by virtue of software, firmware, hardware, or a combination of them installed on the system that, in operation, cause the system to perform the actions. One or more computer programs can be so configured by virtue having instructions that, when executed by data processing apparatus, cause the apparatus to perform 5 the actions.

This technology can provide various benefits to occupants of a property. For example, the use of a doorbell camera and a drone to monitor persons and, potentially, interact with persons at a property can help to deter theft or other crimes from occurring at the property. Specifically, when the system determines that the actions of a person approaching and/or near a property are suspicious, the system can have the drone actively deter theft or other crimes. For example, the system can have the drone follow the person, call emergency services, call an occupant of the property, pretend to call an occupant of the property, open a line of communication to the occupant, pretend to open a line of communication to the occupant, indicate that the owners of a property are home, sound an alarm through speakers of the drone and/or signal an alarm of the property, etc.

Similarly, the use of the drone to monitor persons and interact with persons at a property can help to promote more efficient and controlled interactions between those persons and the occupants or homeowners of a property. For example, the disclosed system can use a drone to interact with persons who are approaching a property prior to them reaching the property. The drone can be used to greet the person, obtain images of the person, obtain audio of the person's voice, request credentials from the person, etc. The drone can use all or part of this information to identify the person prior to them reaching the property, and can notify an occupant of the property of the approaching person and of their identity. Such controlled actions can improve the safety of the occupant and can also be used to more efficiently guide the person to the correct location. For example, if the person is recognized as a visitor, such as a friend or family member, the drone may be used to guide the person along an alternate route to where the occupant is located, such as to the backyard instead of the front door. Alternatively, if the person is recognized as a delivery person, the drone can guide the delivery person to a location that the occupant has specified for items to be delivered such as by the garage instead of the front porch where packages are typically delivered.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for monitoring and managing a property using a drone.

FIG. 2 is a flowchart of an example process for monitoring and managing a property using a drone.

FIG. 3 is a flowchart of an example process for monitoring and managing a property using a drone.

FIG. 4 is a block diagram illustrating an example security monitoring system.

Like reference numbers and designations in the various drawings indicate like elements.

### DETAILED DESCRIPTION

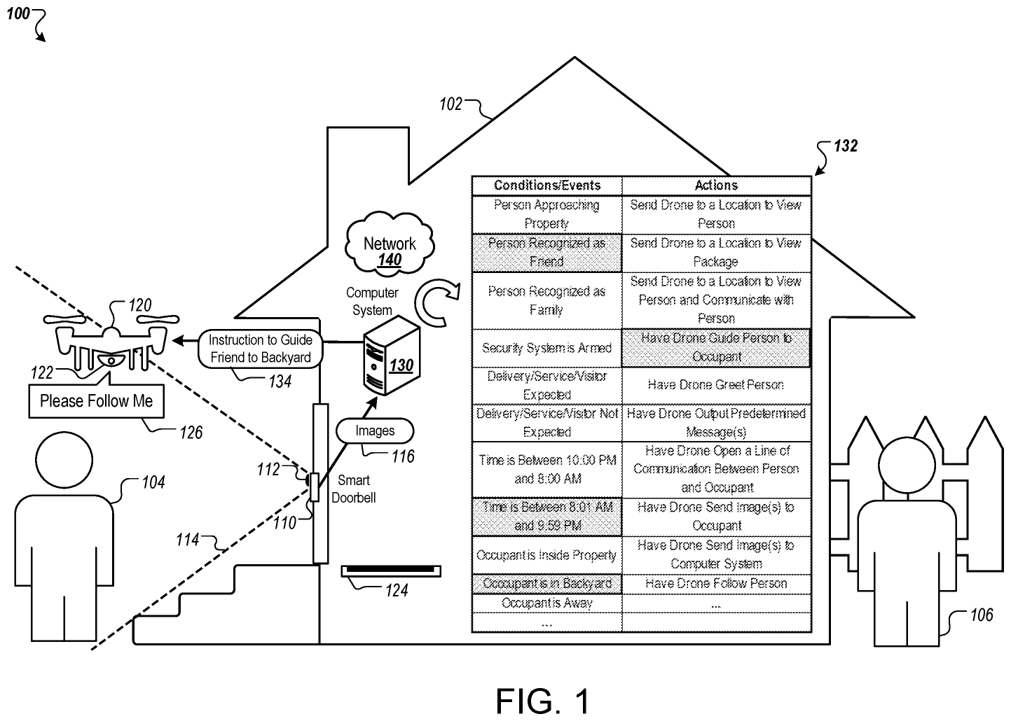

FIG. 1 is a diagram showing an example of a system 100 for monitoring and managing a property 102 using a drone 120. The system 100 includes a computer system 130, a smart doorbell 110 with a doorbell camera 112, and a drone 120 having an onboard camera 122. Various components of the system 100 can communicate over a network 140. The computer system 130 may use images 116 from the doorbell camera 112 to determine events or conditions that are occurring at the property 102, and/or to confirm that expected events or conditions are occurring at the property 102. The computer system 130 may determine and/or generate instructions 134 to send to the drone 120 based on the determined events and/or conditions that are occurring at the property 102.

As an example, the images 116 of the doorbell camera can indicate various events and/or conditions at the property 102, such as that a person is approaching the property 102, that a person is located on the front porch of a property 102, that a person is carrying a package, that a person has dropped off a package, that the facial features of a person approaching and/or near the property match a known person, that the facial features of a person approaching and/or near the property do not match any known persons, that a person has taken a package from the property, etc. These events and/or conditions can serve as factors for the computer system 130 in determining one or more actions to be performed. The computer system 130 can also take into consideration other factors, such as scheduled events, the time associated with an event and/or condition, the location of occupants of the property, etc., in determining the one or more actions to be performed.

When certain activity is detected, e.g., when the computer system 130 determines that a person is approaching the property 102 based on the images 116, the computer system 130 may send instructions to the drone 120 to activate the drone 120. When the drone 120 is activated it may turn on and/or may undock from a docking station 124. Additionally, the drone 120 may be instructed by the computer system 130 to navigate to a location where it can view the detected event/condition indicated by the images 116. For example, the computer system 130 may instruct the drone 120 to undock from the docking station 124 and head outside to a location where it can view the front of the property 102.

In some implementations, the drone 120 is part of the smart doorbell 110. As an example, the smart doorbell 110 may serve as a docking station for the drone 120. The drone 120 may dock in a recessed portion of the smart doorbell 110. For example, the doorbell camera 112 may be a camera of the drone 120. When the drone 120 is activated, the drone 120 may undock from the rest of the smart doorbell 110 and/or navigate to a location instructed by the computer system 130 or a location that the drone 120 itself selects.

The system 100 may be a security system of the property 102. The computer system 130 may be able to communicate with one or more security devices in and around the property 102 in addition to the drone 120 and the smart doorbell 110. As an example, the computer system 130 may be able to receive image data from one or more other cameras of the property 102 (e.g., visible-light cameras and/or infrared light cameras), may be able to receive sensor data from magnetic sensors indicating that a door or window of the property 102 has been opened, may be able receive sensor data from a motion detector indicating the presence of motion in a particular area of the property 102, the computer system 130 may be able to control smart lock(s) of one or more doors of the property 102, etc. The computer system 130 can use these other security devices and/or sensor data from these security devices in determining if one or more occupants of the property 102 are home, and/or a location of the one or more occupants in the property 102 or in the surrounding area (e.g., front yard, back yard, front porch, etc.). Similarly, the computer system 130 can use these other security devices and/or sensor data from these security devices in confirming and/or determining the actions of a person approaching or near the property 102 (e.g., confirm or determine that the person is carrying a package, confirm or determine that the person opened the front door of the property 102, confirm that the person dropped off a package on the front porch of the property 102, confirm or determine that the person picked up a package from the front porch of the property 102, etc.).

The property 102 may be any residential or commercial building such as a house, an apartment complex, an office building, etc.

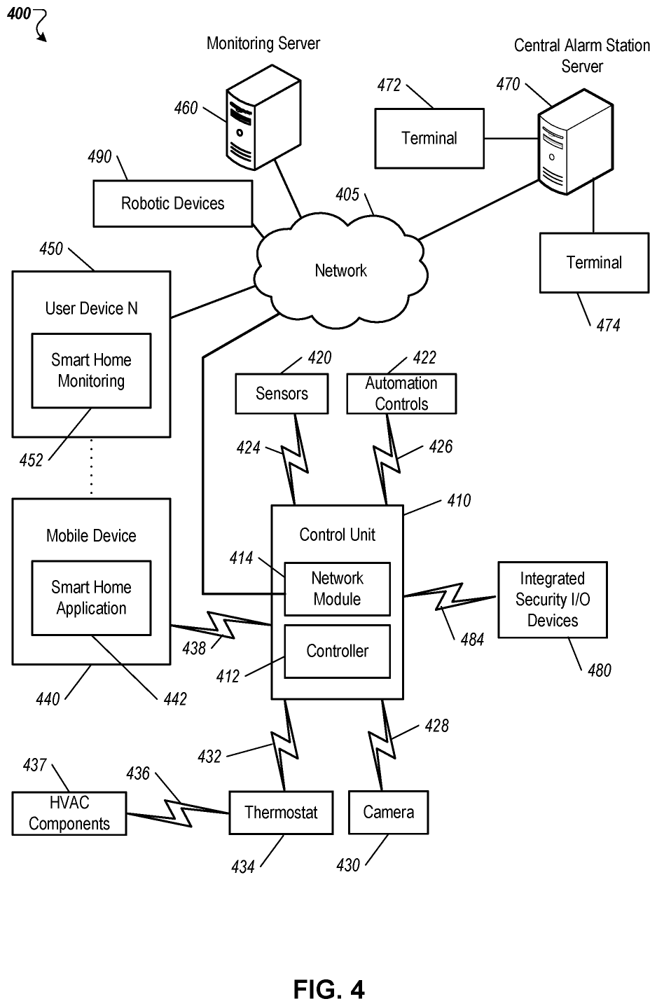

The computer system 130 may include one or more computing devices. The computer system 130 may also include one or more data storage devices. The computer system 130 may communicate with a device of an occupant of the property 102 over the network 140 or over a cellular network. In some implementations, the computer system 130 is the monitoring server 460 shown in FIG. 4.

The drone 120 is able to move around the property 102 using multiple rotors. The drone 120 may include one or more sensors. These sensors may include, for example, an onboard camera 122, one or more additional cameras, one or more audio output devices (e.g., speakers), one or more audio input devices (e.g., microphones), one or more light sources such as one or more light-emitting diodes (LEDs), one or more time of flight (ToF) sensors, a GPS sensor, one or more inertial sensors, one or more depth sensors, etc. The one or more inertial sensors may include one or more accelerometers and one or more rotation sensors, e.g., gyroscopes. The onboard camera 122 may be a visible-light camera. The onboard camera 122 may be part of a depth sensor. The onboard camera 122 may be independently adjustable with respect to the drone 120 such that its field of view (FOV) can be repositioned despite the position and/or pose of the drone 120 remaining the same. The one or more additional cameras may be visible-light cameras, IR cameras, or a combination of visible-light and IR cameras. The one or more additional cameras may be part of a depth sensor.

The drone 120, the smart doorbell 110, and/or other the security device(s) may be able to communicate with the computer system 130, e.g., over the network 140. The drone 120, the smart doorbell 110, and/or other the security device(s) may be able to communicate with the computer system 130 using a wireless connection, such as a Wi-Fi network, a cellular network, a Bluetooth network, etc. One or more of the security device(s) may be able to communicate with the computer system 130 using a wired connection.

In some implementations, the drone 120 may be able to directly communicate with one or more of the security device(s) through a wireless connection. For example, the drone 120 may be able to directly communicate with a smart lock of the property. If, for example, the drone 120 determines that a person near or approaching the property 102 is suspicious (e.g., based on their actions, based on the current conditions such as current time, based on their response to questions posed by the drone 120, etc.), the drone 120 may send instructions to a smart lock of the property 102 to lock the front door. Additionally or alternatively, the drone 120 may provide audio data and/or image data to the computer system 130. In turn, the computer system 130 may determine that the person is suspicious and may send instructions to a smart lock of the property 102 to lock the front door.

In some implementations, a robotic device instead of the drone 120 may be used to monitor the property 102 and actively interacting with persons at the property 102. In these implementations, the robotic device may be a land-based device or land-capable device that can navigate, for example, using one or more wheels and/or legs. As an example, the robotic device may be land and air capable, e.g., capable of both flight and motorized movement on land, through the use of propellers and driven wheels.

The network 140 can include public and/or private networks and can include the Internet.

The techniques disclosed in this document can be used to improve security systems. For example, the use of a doorbell camera and a drone to monitor persons and, potentially, interact with persons at a property can help to deter theft or other crimes from occurring at the property. Specifically, when the system determines that the actions of a person approaching and/or near a property are suspicious, the system can have the drone actively deter theft or other crimes. For example, the system can have the drone follow the person, call emergency services, pretend to call an occupant of the home and/or pretend to open a line of communication to the occupant, indicate that the owners of a property are home, sound an alarm through speakers of the drone and/or signal an alarm of the property, etc.

As shown in FIG. 1, a person 104 has approached the property 102. The smart doorbell 110 can use the doorbell camera 112 with a field of view (FOV) 114 to capture images 116. The images 116 can indicate, for example, that the person 104 is approaching the property 102, that the person 104 is near the property 102 (e.g., within 100 ft of the property 102, within 50 ft of the property 102, within 20 ft of the property 102, etc.), that the person 104 is on a front porch of the property 102, and/or that the person 104 is leaving the property. The smart doorbell 110 may consistently capture and send images to the computer system 130 for the computer system 130 to analyze (e.g., two images per second, one image per second, one image per five seconds, etc.). Alternatively, the smart doorbell 110 may start capturing and/or sending images to the computer system 130 for the computer system 130 to analyze when it detects movement (e.g., using the doorbell camera 112 and/or using a motion sensor).

The computer system 130 can receive the images 116 from the smart doorbell 110, e.g., over the network 140. In response to receiving the images 116, the computer system 130 can process the images 116, e.g., using known imaging processing techniques such as object recognition and/or facial recognition, to determine one or more conditions and/or events. For example, using the images 116, the computer system 130 can determine that the person 104 is near the property 102 (e.g., within 100 ft, 50 ft, or 20 ft of the property 102), that the person 104 is approaching the property 102, that the person 104 is leaving the property 102, etc. Similarly, the computer system 130 can user the 114 to try and identify the person 104, e.g., by using facial recognition techniques to identify a portion of the image data in the images 116 that correspond to the face of the person 104 and to compare that portion of the image data with stored image data of one or more known persons.

In some cases, the computer system 130 uses the images 116 to help track and localize the drone 120 in flight, and/or to guide the drone 120 back to land at the docking station 124. For example, the drone 120 can use the front door of the property 102 as a landmark to help localize itself in flight (e.g., to help correct for any errors that have occurred in odometry).

The stored image data can include, for example, image data of various persons that are associated with the property 102 and/or with the occupants of the property 102. The various persons may be categorized. These categories can include homeowners, occupants, friends, family members, frequent visitors, delivery persons, etc.

A person may be categorized as a friend (e.g., a friend of an occupant of the property 102) based on one or more of the following: the computer system 130 recognizing the person as a prior visitor of the property 102 and the person having been labelled as a friend by an occupant; an occupant having uploaded a picture of the person to the computer system 130 and indicating that the picture is of a friend; and/or the person being identified as a friend in the contacts of an occupant stored on a computing device and/or in a social media platform of the occupant).

Similarly, a person may be categorized as a family member (e.g., a family member of an occupant of the property 102) based on one or more of the following: the computer system 130 recognizing the person as a prior visitor of the property 102 and the person having been labelled as a family member by an occupant; an occupant having uploaded a picture of the person to the computer system 130 and indicating that the picture is of a family member or a specific type of family member; and/or the person being identified as a family member in the occupant's contacts stored on a computing device and/or in a social media platform of the occupant).

A person may be categorized as a frequent visitor based on the computer system 130 automatically recognizing that the person has visited the property 102 a threshold number of times (e.g., five visits, ten visits, twenty visits, etc.) or a threshold number of times in a given time period (e.g., four times over the past month), and the person having been granted access during their previous visits or granted access during a threshold percent of their previous visits (e.g., 80%, 85%, 90%, etc.).

A person may be categorized as a suspicious person based on the computer system 130 automatically recognizing that the person had previously visited the property 102 and having deemed the person's actions during their visit as suspicious (e.g., attempted to enter the property 102 without knocking on the front door or ringing the smart doorbell 110, attempting to open a window of the property 102, taking a package or other item from the property 102, etc.). Similarly, a person may be categorized as a threatening person based on the computer system 130 automatically recognizing that the person had previously visited the property 102 and having deemed the person's actions during their visit as threatening (e.g., broke a window of the property, broke a door of the property, attacked the occupant 106 or another visitor of the property 102, etc.).

The homeowner of the property 102 and/or the occupants of the property 102 may be able to set specific rules for these various categories of persons, such as access rules (e.g., times or time ranges when persons in this category are permitted to visit, the extent of access to the property persons in this category are permitted to have, etc.) and particular interaction rules (e.g., persons that are categorized as family members, friends, or frequent visitors are automatically greeted by the drone 120, whereas persons that are categorized as suspicious are monitored from a distance and/or warned by the drone 120 to leave the area). For example, persons in the family member or in the friends category may automatically get access to the property 102, and/or may be automatically guided to the occupant 106 by the drone 120 once they are recognized as a friend or family member. In contrast, if the drone 120 recognizes a person as a person in the threatening persons category, the drone 120 may automatically call the police and notify the occupant 106.

In some cases, a person may belong to multiple categories. For example, a persons who is a father of the occupant 106 and frequently visits the occupant 106 may be categorized as both a family member and as frequent visitor. Similarly, a person categorized as a delivery person but who has been detected as attempting to enter the property 102 may be also categorized as a suspicious person.

The stored image data may also include images of objects that are associated with known (e.g., categorized) persons. For example, the stored image data may include images of vehicles of occupants of the property 102, vehicles of friends of occupants of the property 102, vehicles of family members of occupants of the property 102, vehicles of frequent visitors of the property 102, vehicles of suspicious persons, etc. and suspicious persons (e.g., persons who have previously approached the property 102 without explanation or tried to enter the property 102 without permission, unrecognized persons who have been hanging out around the property 102 for extended periods of time and/or at strange hours, persons who have previously taken a package from the property 102, persons that an occupant of the property 102 has labelled as a known threat, etc.).

In addition to processing the images 116, the computer system 130 can access information to help in determining conditions/events based on the images 116, and/or to identify additional conditions/events. For example, the computer system 130 can access a schedule that indicates scheduled visits and deliveries. The computer system 130 may also access, if available, an image of the delivery person or visitor. The computer system 130 may use such images along with the delivery schedule as an additional form of confirmation before allowing a delivery person access to the property to make the delivery.

Specifically, a schedule may indicate a time or a time range that a package is expected to be delivered, a time or time range that a serviceman is expected to arrive, a time or time range that each of the one or more occupants of the property 102 are expected to be at the property 102, a time or time range that each of the one or more occupants of the property 102 are expected to be away from the property 102, and/or a time or time range that a visitor is expected to arrive. This computer system 130 may access this information, for example, from calendar data belonging to the one or more occupants of the property 102. A schedule may also indicate inferred information. For example, the computer system 130 may have an itinerary information corresponding to an occupant or a visitor. The computer system 130 can use the expected arrival time from the itinerary along with an estimated time of travel between the particular airport and the property 102 to determine an estimated time that the occupant or visitor is expected to arrive at the house, and/or to calculate a time range (e.g., with a standard deviation of two) for when the visitor or occupant is expected to arrive. The computer system 130 may add this time or time range to the schedule.

As another example, the computer system 130 can access a list that includes the information of known persons. For example, for each known person, the list may include one or more of a name, an age, a birthday, an eye color, a hair color, a height, a vehicle make, a vehicle color, a vehicle model, a vehicle year, a license plate number, an indication of whether they are an occupant, a family member, a friend, a co-worker, etc. As will be described in more detail below, this information can be used by the computer system 130 and/or the drone 120 to confirm the identity of a person approaching or near the property 102. For example, the drone 120 may be sent to greet a person approaching the property 102. In greeting the person, the drone 120 may ask the person for their name. If the name does not match an expected name (e.g., a name of a visitor that was scheduled to arrive, or a name of a known person that the computer system 130 identified the person as), the computer system 130 and/or the drone 120 may deem the person suspicious. In deeming the person suspicious, the drone 120 (or the computer system 130) may take different actions with respect to the person. For example, the drone 120 may ask the person additional questions, such as “who are you here to see?”, “what is your business with the Smith's?”, etc.

Furthermore, the schedule may further indicate times that correspond to suspicious activity. For example, the schedule may indicate that computer system 130 should treat activity, such as persons near or approaching the property 102, with higher suspicion during the hours of 10:00 PM and 8:00 AM. This time range may be set by an occupant of the property 102. This time range may correspond to when a security system of the property 102 (e.g., the computer system 130) is placed in an armed state. Thus, the time range may include one or more dynamic time ranges that directly correspond to when the security system of the property 102 is in an armed state. Alternatively, this time may correspond to a time range when the computer system 130 determines that the one or more occupants of the property 102 are generally asleep (e.g., based on image data, sensor data indicating a lack of movement inside the property 102 during these times, sensor data indicating no or few doors/windows of the property 102 opening/closing during these times, etc.).

As will be discussed in more details below, the actions taken by the computer system 130 and/or the drone 120 may depend on whether the current time falls within a time range that is associated with high suspicion. For example, if the schedule indicates that the detected activity occurred during times of higher suspicion, the computer system 130 may choose to send an alert.

Moreover, the schedule may indicate times when different groups of persons are permitted, not permitted, or should be treated with higher suspicion. For example, an occupant of the property 102 may indicate that friends are permitted between the hours of 9:00 AM and 9:00 PM, that friends are not permitted between the hours of 12:00 AM and 8:59 AM, and that friends should be treated with higher suspicion between the hours of 9:01 PM and 11:59 PM (e.g., which may lead to different instructions sent to the drone 120 that provide for increased monitoring, more detailed interrogation of the friend by the drone 120 before opening up a line of communication between an occupant and the friend or before leading the friend to the occupant, etc.). Similarly, the occupant of the property 102 may indicate that unknown persons (e.g., deliverymen and/or servicemen) are only permitted between the hours of 9:00 am and 5:00 PM, and that persons identified as family are permitted all hours.

The computer system 130 may use the schedule with the current time in order to determine various conditions/events. For example, in response to determining that the person 104 is a friend, the computer system 130 may refer to a schedule to determine that the current time corresponds with a time when friends are not permitted to the property 102. The computer system 130 may send instructions to the drone 120 to navigate to a location near the person 104 and inform the person that, for example, the occupants of the property are asleep (even if they are not), that it is too late, that the occupants of the property are away (even if they are not), etc. In some cases, the computer system 130 and/or the drone 120 may send a notification to one or more occupants of the property 102 informing them that the person 104 is near/outside of the property 102. The notification may include one or more of a name of the friend that the person 104 is identified as, a stored picture of the friend that the person 104 is identified as, a recent picture taken using the doorbell camera 112 and/or the onboard camera 122 of the person 104 person, and the location of the person 104 (e.g., front yard, garage, front porch, backyard, etc.).

As another example, the computer system 130 can access sensor data from other security devices of the property 102. For example, the computer system 130 can access and/or receive one or more of image data from one or more other cameras of the property 102, sensor data from magnetic sensors indicating that a door or window of the property 102 has been opened, and sensor data from a motion detector indicating the presence of motion in a particular area of the property 102. For example, the computer system 130 may receive image data from a camera monitoring a garage of the property 102. The computer system 130 may determine from the received image data that a vehicle has pulled up to the garage and that a person has exited the vehicle. The computer system 130 may determine that the person is not in (or yet in) the FOV 114 of the doorbell camera 112. In response to this determination, the computer system 130 may send instructions to activate the drone 120 such that it undocks from the docking station 124 and moves to a location such that it can view the person using the onboard camera 122.

Additionally or alternatively, the computer system 130 may be able to control one or more other security devices of the property 102. For example, the computer system 130 may be able to lock or unlock smart lock(s) of one or more doors of the property 102, change an orientation of a camera of the property 102 to change its line of sight, change a zoom of a camera of the property 102 to widen or narrow the camera's field of view, sound an alarm of the property 102, etc. As an example, the computer system 130 may track a person that exited a vehicle using a camera monitoring a garage of the property 102 until the drone 120 reaches a location where it can view the person. The computer system 130 may send updated information or instructions to the drone 120 based on the movements of the person. For example, the computer system 130 can send an estimated location of the person to the drone 120, e.g., every second, every two seconds, every five seconds, etc. The drone 120 can use this information to update a location that it is navigating to in order to view the person. Alternatively, the computer system 130 can send updated instructions to the drone 120 when it detects that a location of the person has changed. These updated instructions may indicate a new location for the drone 120 to navigate to in order to view the person with the onboard camera 122.

In the example of FIG. 1, the computer system 130 has determined conditions and/or events occurring at the property 102. A list of potential conditions and/or events is shown in the first column of a table 132. As described above, in making this determination, the computer system 130 can use the images 116 and/or other information such as a schedule, an indication that the security system of the property 102 (e.g., the system 100) is armed, stored image data, images captured from one or more other cameras of the property 102, sensor data captured from one or more other security devices of the property 102, and/or a current time. Here, the computer system 130 has identified, using the images 116 and/or stored image data (e.g., stored on a database accessible to the computer system 130 such as a local hard drive or a database maintained by a cloud computing provider), the person 104 near the property 102 as a friend of an occupant 106 of the property 102. The computer system 130 may also determine a condition that the current time falls in a time range between 8:01 AM and 9:59 PM that corresponds with a time when visitors are permitted, e.g., as indicated by a schedule that the computer system 130 is able to access (e.g., a schedule stored locally or a scheduled stored on the cloud). Additionally, the computer system 130 may determine a condition that the occupant 106 is presently located in the backyard of the property 102.

Based on the one or more conditions and/or events determined by the computer system 130, the computer system 130 may determine one or more actions to perform. A list of potential actions to perform is shown in the second column of the table 132. These actions can include actions to be performed by the computer system 130. These actions can additionally or alternatively include action that should be performed by the drone 120, the smart doorbell 110, or other security devices of the property 102 (e.g., actions to be performed by a smart lock, etc.). As an example, if the person 104 is determined to be on the front porch of the property 102 (e.g., as a condition/event), the computer system 130 may select an action to communicate with the person 104 through the smart doorbell 110 instead of through the drone 120. Each of the actions to be performed by security devices of the property 102 may correspond to instructions that the computer system 130 will generate and/or send to the corresponding security device. For example, upon detecting a person approaching the property 102 (e.g., as an event), the computer system 130 may send instructions to activate the drone 120. That is, upon detecting a person approaching the property 102, the computer system 130 may send instructions to the drone 120 to undock from the docking station 124 and to navigate outside to await further instructions. In the example of FIG. 1, the drone 120 may have already received instructions from the computer system 130 activating the drone 120.

Based on the condition that the person 104 is recognized as a friend of the occupant 106, the condition that the time is between 8:01 AM and 9:59 PM when visitors are permitted to the property 102, and/or the condition that the occupant 106 is in the backyard, the computer system 130 determines an action that the drone 120 should guide the person 104 to the occupant 106, or selects the action that the drone 120 should guide the person 104 to the occupant 106 from the list of potential actions in the table 132.

The computer system 130 can access and/or generate instructions corresponding to determined/selected action. For example, the computer system 130 can generate instructions 134 to send to the drone 120 over the network 140. The instructions 134 can provide that the drone 120 should guide the person 104 to the backyard where the occupant 106 is located.

The instructions 134 may additionally provide that the drone 120 output a predetermined message corresponding to the action to guide a person. For example, the instructions 134 may indicate that the drone 120 output a message 126 through speakers of the drone 120. The message 126 can be or include, for example, an auditory message of “please follow me.” The message 126 may be a predetermined message for actions where the drone 120 is instructed to guide a visitor, such as a friend or family member of the occupant 106. The message 126 may additionally or alternatively indicate of the occupant 106. For example, the message 126 can be or can include, for example, an auditory message of “Dave is in the backyard. I'll guide you to him.”

After outputting the message 126, the drone 120 can start navigating towards the backyard of the property 102 where the occupant 106 is presently located. The drone 120 can move at a speed that allows the person 104 to keep up while walking.

In some cases, the drone 120 can be used to guide visitors, such as the person 104, in different scenarios. For example, if the front door is not immediately visible from where the person 104 is located (e.g., from where they have parked) and if the computer system 130 identifies the person 104 (e.g., using images collected from the onboard camera 122 and/or from one or more cameras installed around the property 102), the computer system 130 can send instructions to the drone 120 to guide the person 104 to the front door of the property 102. The instructions may indicate an estimated location of the person 104, a location that the drone 120 should navigate to in order to view the person 104 with the onboard camera 122, an orientation of the drone 120, and/or an orientation of the onboard camera 122.

As another example, the drone 120 can be used to guide a visitor, such as the person 104, to a particular location to wait for the occupant 106. For example, the computer system 130 may send instructions to the drone 120 providing that the drone 120 should guide the person 104 to the person 104's vehicle, to the front porch of the property 102, to the back yard of the property 102, or to a pool of the property 102 while the occupant 106 is notified. The instructions may additionally provide (or the drone 120 may decide to output) one or more messages. These messages may include suggestions/instructions that the person 104 wait at a particular location for the occupant 106. These messages may include an indication that the occupant 106 has been notified of the person 104's arrival. As an example, the drone 120 may output a first message of “Please follow me to the backyard”, followed by a second message when the person 104 and/or the drone 120 reaches the backyard of the property 102 of “Please wait here. Dave has been notified of your arrival and will be out shortly.” Alternatively, the drone 120 may recognize that Dave arriving and greeting the visitor. In response to this recognition, the drone 120 may return to the front door of the property 102.

As another example, the drone 120 can be used to guide deliveryman and/or serviceman to specific areas of the property 102. For example, if the computer system 130 determines that a deliveryman is approaching the property 102 (e.g., based on determining that a person is approaching the property 102 from the images 116 and/or based on the current time corresponding to a scheduled time or a scheduled time range for when a package is expected to be delivered), the computer system 130 can send instructions to the drone 120 to guide the deliveryman to a particular location of the property 102 where packages should be dropped off (e.g., a location selected by the occupant 106 through an app running on a computing device of the occupant 106, and/or specified by the occupant 106 through a security panel of the property 102's security system/the computer system 130). Similarly, if the computer system 130 determines that a serviceman is approaching the property 102 (e.g., based on determining that a person is approaching the property 102 from the images 116 and/or based on the current time corresponding to a scheduled repair time or a scheduled time range for when a serviceman is expected to arrive), the computer system 130 can send instructions to the drone 120 to guide the serviceman to a particular location inside or around the property 102 where the repair/service is needed (e.g., for pool service, the drone 120 would guide the serviceman to the backyard of the property 102; for water heater service and/or electrical service, the drone 120 could lead the serviceman to a utility closet inside the property 102; the drone 120 could lead the serviceman to a cable junction box on the side of the property 102, the drone 120 could lead the serviceman to a etc.).

As another example, the drone 120 can be used to guide short term rental guests (or hotel/motel guests). The computer system 130 may access an image of the short term rental guests and compare the images to images captured using the onboard camera 122 of the drone 120, using the doorbell camera 112, and/or other cameras of the property 102 to identify persons approaching or near the property 102 as short term rental guests. The computer system 130 may proceed to send instructions to the drone 120 to guide the short term rental guests to a particular location, such as a room or rooms where they will be staying, to a guest house/carriage house, etc.

Continuing the example, the drone 120 may assess a visitor's garb or personal protective equipment (PPE) and direct them to take actions based on their garb or PPE. For example, the drone 120 may direct a visitor to don a mask before entering the property 102, to remove their shoes before entering the property 102 or upon entering the property 102. Similarly, the drone 120 may direct a visitor to don a mask before guiding the person to a particular section of the property 102, e.g., a location where other persons are located. In response to detecting that a visitor is not complying with the garb or PPE requirements (e.g., those set by an owner of the property 102 and/or an occupant of the property 102), the drone 120 may, for example, leave monitoring the front door to intercept the visitor. Upon interception of the visitor, the drone 120 may guide the visitor to an area where they are permitted, may communicate the garb and/or PPE requirements to the visitor, may guide the visitor to an area where PPE items are located (e.g., an area where disposable masks and hand sanitizer are located), may deliver a PPE item (e.g., a mask) directly to the visitor, or may direct them to an area where garb can be added or removed (e.g., the drone 120 can guide the visitor to an area adjacent the front door where shoes can be removed and stored).

In some cases, the drone 120 can be used to alert occupants of the property 102. For example, if the a threshold amount of time has passed since the computer system 130 notified the occupant 106 that a visitor has arrived at the property 102 without response from the occupant 106 and/or without the occupant 106 greeting the visitor, the computer system 130 can send instructions to the drone 120 to navigate to a location where it can communicate with the occupant 106 and output an auditory or visual message to the occupant that indicates that a visitor has arrived.

In some cases, the drone 120 is activated, e.g., by the computer system 130, when a person is detected as being near and/or approaching the property 102. Similarly, the drone 120 can be activated, e.g., by the computer system 130, when a vehicle is detected as being near the property 102 (e.g., vehicle is parked in a drive way of the property 102) and/or as approaching the property 102 (e.g., vehicle pulls into a drive way of the property 102). Additionally or alternatively, the drone 120 may be manually activated by the occupant 106, e.g., through a mobile application running on a device of the occupant 106.

In some cases, the drone 120 is activated when a schedule (e.g., calendar) indicates that a person and/or vehicle should be arriving at the property 102. For example, the computer system 130 may activate the drone 120 (e.g., to put it in a guard/monitor mode) when a schedule indicates that a serviceman is expected to about to arrive (e.g., is expected to arrive in ten minutes, five minutes, one minute, etc.), or that a deliveryman is expected to drop off a package.

In some cases, the drone 120 can be used to verify that a package or other items was delivered at the property 102. For example, the computer system 130 can use images obtained by the doorbell camera 112 (and/or one or more other cameras) to determine that a package was likely delivered. Specifically, the images may indicate one or more of that a person was approaching the property 102 with an item that might be a package, that a person was approaching a particular part of the property 102 where packages are typically dropped off (e.g., front door, front porch, etc.), that a person was departing the property 102 without an item they were previously carrying, or that a person performed movements associated with dropping off a package (e.g., leaned over, bent knees, etc.). The computer system 130 may not be able to confirm that the package was delivered using the doorbell camera 112 (and/or using one or more other cameras) due to the package not currently being visible.

In response to the determination that a package was likely delivered, the computer system 130 can send instructions to the drone 120 providing for the drone 120 to navigate to a location where it can view a likely drop-off area of the package and can likely view the package. A likely drop-off area can be an area where packages are typically delivered, such as the front door or front porch of the property 102, an area that is stated in delivery notifications (e.g., an email or text messages indicating that a package was “left on the front porch” of the property 102), and/or an area that corresponds to tracking information provided through a delivery company's website or mobile application (e.g., tracking information on USPS website indicates that a package “was left by the garage” of the property 102). Alternatively, a likely drop-off area can be an area where a person identified as carrying an item that might be a package was approaching and/or where the person performed one or more motions that correspond to dropping off a package (e.g., if a deliveryman was seen headed towards the garage with a package and was seen leaving without a package, the computer system 130 may determine that the garage is the likely drop-off area for the package). The drone 120 can collect images using the onboard camera 122. The drone 120 and/or the computer system 130 can analyze the images to determine whether or not a package was delivered. If the package is not identified from the images, the drone 120 may search other locations in or around the property 102 (e.g., one or more locations that are not expected locations; one or more locations that are not expected locations but are still probable due to, for example, the delivery person having access to the one or more locations such as a side yard of the property 102; etc.). Once it is determined that package was delivered, the drone 120 and/or the computer system 130 can generate and send a notification to the occupant 106 indicating that a package was delivered. The notification may include an image of the package, such as an image of the shipping label.

After a package has been delivered, the drone 120 can be used to guard/monitor a package or other items of the property 102. For example, if the computer system 130 determines that a package has been delivered to the property 102, the computer system 130 may send instructions to the drone 120 to guard/monitor the package. The drone 120 may navigate to a position (or modify a position of the onboard camera 122) such that the package is viewable from the field of view of the onboard camera 122. The drone 120 may select this position based on a known location of the package the drone 120 determines using image data from the onboard camera 122, or that the drone 120 receives from the computer system 130. The drone 120 may position itself (or the onboard camera 122) such that both the package and a portion of the property 102 (e.g., the front door, the front porch, the area leading up to the front door, etc.) are placed in the field of view of the onboard camera 122. The drone 120 may continue to guard/monitor the package until it receives instructions from the occupant 106 to stop guarding/monitoring the package (e.g., instructions provided through an app running on a computing device of the occupant 106), until the occupant 106 or other occupant of the property 102 retrieves the package, or until the drone 120 (or the computer system 130) determines that the person who delivered the package has left without the package.

In some cases, the drone 120 can be placed into a guard/monitor mode by an occupant of the property 102. For example, in response to receiving a notification from the computer system 130 indicating that a package has been delivered, the occupant 106 can select an option through an app of a computing device of the occupant 106 (e.g., a smart phone) for the drone 120 to guard the package until the occupant 106 arrives at the property 102. The occupant 106 may be able to select a time range for the drone 120 to guard/monitor an item such as a package, e.g., through an app running on a computing device of the occupant 106. The occupant 106 may be able to select one or more items (e.g., a package, a piece of outdoor furniture, the front door of the property 102, a fence door to the backyard of the property 102, etc.) for the drone 120 to guard/monitor.

In some cases, as discussed above, the drone 120 can be used to greet and/or screen visitors of the property 102. For example, the drone 120 can open up a line of communication between a visitor and the occupant 106 using a microphone and speaker of the drone 120 to communicate. A similar line of communication can be opened between a visitor and the occupant 106 using the smart doorbell 110. The drone 120 may ask the visitor one or more questions (e.g., “what is your name?”, “who are you here to see?”, “how can I help you?”, etc.). The drone 120 may send the visitor's response(s) to the question(s) to the occupant 106, e.g., in the form of a video and audio stream from the onboard camera 122 and a microphone of the drone 120. The occupant 106 may select an option on how to proceed (e.g., from a list of options, through an auditory command, through a typed command, etc.) through an app running on a computing device of the occupant 106. For example, if the visitor states that their name is “John”, the occupant 106 may use this information in selecting a command to have the drone 120 guide the visitor inside the property 102. The drone 120 may ask the visitor for credentials, such as an ID card, a passphrase, or contactless authentication. The drone 120 may use the credentials to automatically authenticate the identity of the visitor. The drone 120 may additionally or alternatively provide the credentials to the occupant 106, e.g., for authentication, confirmation of authentication, or confirmation of authentication failure.

In a case where a vehicle has arrived at the property 102, the system 100 may detect the vehicle. For example, the smart doorbell 110 may capture images using the doorbell camera 112 that show the vehicle entering a driveway of the property 102. The computer system 130 may receive these images and may analyze the images to determine that the vehicle has entered the driveway of the property 102. The computer system 130 (or the smart doorbell 110) may further determine that the vehicle does not belong to the occupant 106, e.g., based on one or more of the make of the vehicle not matching a make of the occupant 106's vehicle, the model of the vehicle not matching a model of the occupant 106's vehicle, the color of the vehicle not matching a color of the occupant 106's vehicle, or the license plate code of the vehicle not matching a license plate code of the occupant 106's vehicle.

In response to determining that the vehicle does not belong to the occupant 106, the computer system 130 (or the smart doorbell 110) may send instructions to the drone 120 to greet a person exiting the vehicle. In greeting the person, the drone 120 may output one or more predetermined messages, such as one or more questions, statements, greetings, etc. The drone 120 may record statements made by the person, including responses to any questions asked. The drone 120 may provide the recorded statements to one or more of the computer system 130, to a centralized server, to a cloud server, a computing device of the occupant 106, etc. The computer system 130 may generate and send a notification to a computing device of the occupant 106 indicating one or more of that a visitor has arrived, that the visitor has parked in the driveway of the property 102, a name provided by the person, etc. The notification may include statements provided by the person, audio clip(s) of the person speaking, image(s) of the person, etc.

In some cases, the drone 120 can perform an action without input from the occupant 106 depending on the visitor's response(s) and/or other screening criteria. For example, if the visitor fails to give a response, the drone 120 may repeat the question(s), may repeat the question(s) with a louder speaker volume, may repeat the question(s) with a different or modified synthesized voice (e.g., modify by lowering pitch of the synthesized voice), and/or may more automatically signal an alarm of the property 102. The screening criteria may include expected actions, suspicious actions, conditions/events at the property 102, such as the current time (e.g., if the current time corresponds to a time when visitors are or are not permitted), the location(s) of the occupants of the property 102 (e.g., property 102 could be more at risk if the occupant 106 is away from the property 102), the state of the occupants of the property 102 (e.g., the occupants and the property 102 may be more at risk if the occupants are asleep), etc. As an example of an expected action, the drone 120 and/or the computer system 130 may deem a visitor less suspicious if their actions include expected actions, such as approaching the front door of the property 102, ringing the smart doorbell 110, waiting on the front porch of the property 102, etc. As an example of suspicious responses, the drone 120 and/or the computer system 130 may deem a visitor suspicious if they fail to give a response, fail to give a response that corresponds to the question asked, fails to identify an occupant of the property 102 (e.g., where the drone 120 asks the visitor who they are here to see), etc. Similarly, the drone 120 (or the computer system 130) may determine that the visitor's actions are suspicious and deem the visitor suspicious if they try to enter the property 102, if they fail to knock on the front door or ring the smart doorbell 110 of the property 102, if they attempt to enter the backyard of the property 102, if they attempt to open a window or enter through a window of the property 102, if they break a window of the property 102, etc. In response to determining that the visitor's actions are suspicious, the drone 120 (or the computer system 130) may immediately notify the homeowner and/or occupants of the property 102. The drone 120 (or the computer system 130) may determine that the visitor's actions are threatening and deem the visitor as a threat if they break a window of the property 102, break through a locked door of the property, etc. In response to determining the visitor's actions are threatening, the drone 120 (or the computer system 130) may immediately call the police.

As an example of an automatic action performed by the drone 120, the drone 120 may pretend to open up a line of communication between the occupant 106 and the visitor if the drone 120 (or the computer system 130) determines that the visitor's response(s) and/or actions are suspicious, and/or based on certain conditions/events occurring at the property. Specifically, the drone 120 (or the computer system 130) may determine that the visitor is suspicious based on misidentifying the occupant 106 and based on the current time corresponding to a time when visitors are not permitted. The drone 120 (or the computer system 130) may further determine that the occupant 106 is not located at the property 102. Based on this, the drone 120 may pretend to open up a line of communication between the visitor and the occupant 106. In pretending to open up a line of communication, the drone 120 may play one or more recorded sound clips of the occupant 106. For example, if the visitor is determined to be suspicious, the drone 120 may play a sound clip of the occupant 106 stating “Who is this?” and, later after a response is received or threshold amount of time has passed, “Thanks for coming by but we are busy.” As another example, if the visitor is determined to be highly suspicious (e.g., based on the visitor's actions being highly suspicious, such as attempting to enter the property 102 or stealing something from the property 102; based on the visitor performing a threshold number of suspicious actions; and/or based on the conditions/events at the property 102), the drone 120 may play a sound clip of the occupant 106 stating “Stop what you are doing and leave immediately. We have already called the police.” The drone 120 (or the computer system 130) may determine that the visitor's response(s) are suspicious if they fail to give a response, fail to give a response that corresponds to the question asked, fails to identify an occupant of the property 102 (e.g., where the drone 120 asks the visitor who they are here to see), etc. Similarly, the drone 120 (or the computer system 130) may determine that the visitor's actions are suspicious if they try to enter the property 102 without knocking or ringing the smart doorbell 110, if they try to enter the backyard of the property 102, if they try to open a window or enter through a window of the property 102, if they break a window of the property 102, etc.

In some implementations, as mentioned above, the drone 120 is part of the smart doorbell 110. That is, the drone 120 may be capable from undocking from a portion of the smart doorbell 110 that remains fixed to the property 102. The drone 120 may undock from the portion of the smart doorbell 110 when it receives instructions to do so from the computer system 130, when it detects that a person or vehicle is approaching the property 102, when it receives an indication that a visitor, deliveryman, or serviceman is close to arriving at the property 102, etc. The onboard camera 122 may be the same as the doorbell camera 112.

In these implementations, the docking station 124 for the drone 120 may replace an existing doorbell button and draw power to charge the drone 120 from a doorbell transformer. Similarly, the docking station 124 for the drone 120 may be integrated into the smart doorbell 110. The drone 120 may re-dock and charge next to the front door of the property 102 after each flight. In some cases, both the drone 120 and the docking station 124 might have a camera, mic/speaker, doorbell button, and/or other sensors, such that the docking station 124 could maintain full functionality while the drone 120 is in flight or in a guard mode. Additionally, the docking station 124's camera (e.g., the doorbell camera 112) or other sensors might be used to help track and localize the drone 120 in flight, and/or to guide the drone 120 back to land at the docking station 124.

In some implementations, there may be additional docking stations which the drone 120 can use to perch, charge, and monitor different fields of view of the property 102. These additional docking stations may be able to charge the drone 120 when the drone 120 lands on them.

In some implementations, the drone 120 can control other parts of the system 100. For example, the drone 120 may be able to sound a chime of the smart doorbell 110, e.g., if it determines that a known person is approaching the front door of the property 102. Similarly, the drone 120 may be able to sound an alarm of the property 102, e.g., if it determines that a package was taken from the property 102, that a break in occurred at the property 102, that a break in was attempted at the property 102, etc.

In some implementations, the system 100 (e.g., the computer system 130, the smart doorbell 110, and/or the drone 120) performs pre-roll observation. For example, before any persons reach the front door and/or the front porch of the property 102, the computer system 130 can begin recording image data of any vehicles or persons that are approaching the property 102. For example, the computer system 130 can use the doorbell camera 112 and/or one or more other cameras of the property 102 to determine if any vehicles or persons are approaching the property 102. Upon determining that a person or vehicle is approaching the property 102, the computer system 130 can start saving the image data collected by the smart doorbell 110 and/or other cameras, can send instructions to the smart doorbell 110 and/or other cameras to turn on, can send instructions to the smart doorbell 110 and/or other cameras to start collecting image data, etc.

In some implementations, the system 100 (e.g., the computer system 130, the smart doorbell 110, and/or the drone 120) is used for package monitoring and theft prevention. For example, if the images 116 indicate that a person has removed a package from the front porch of the property 102 (e.g., an event determined by the computer system 130 from the images 116), the computer system 130 can determine an action and/or select an action for the drone 120 to pursue the thief and proceed to send corresponding instructions to the drone 120. The computer system 130 may also send the same or similar instructions in response to determining other events or conditions occurring at the property 102. For example, the computer system 130 may send instructions to the drone 120 to pursue a person if it determined based on the images 116, based on other images, and/or based on other sensor data that the person entered the property 102, broke into the property 102 (e.g., magnetic door sensor indicates that door opened despite smart lock being locked, acoustic window breakage sensor indicating that window has been broken, a vibration window breakage sensor indicating that a window has been broken, etc.), or stole an item other than a package from the property 102.

In pursuing a target person (e.g., a thief), the drone 120 may be capable of recognizing the target person and/or distinguishing the target person from other persons. The drone 120 may be able to do this through one or more of the following methods: standard video analytics target-tracking; use of overhead view using the onboard camera 122 of the drone 120 to help track one person, e.g., in a crowd; facial recognition (e.g., using one or more images of the person captured by the doorbell camera 112, by another camera of the property 102, and/or by the onboard camera 122); gait recognition (e.g., using one or more images of the person captured by the doorbell camera 112, by another camera of the property 102, and/or by the onboard camera 122); body heat signature (e.g., using one or more images of the person captured using an IR camera of the smart doorbell 110, of the drone 120, and/or of the property 102); smartphone/wearable Wi-Fi fingerprinting; location tracker or beacon attached to a stolen package; or a visual tag attached to the stolen package (e.g., using the onboard camera 122 to verify a shipping barcode or a matrix code on a package that the target person is carrying).

In pursuing a target person (e.g., a thief), the drone 120 may be able to recognize the target person and continue to track them as both the drone 120 and the target person are moving. Furthermore, in pursuing a target person, the drone 120 may navigate such that it remains at least a threshold distance away from the target person (e.g., three meters, five meters, ten meters, etc.), and/or a threshold distance above the target person (e.g., three meters, five meters, ten meters, etc.). Similarly, in pursuing a target person, the drone 120 may dynamically determine how close to get to the target person. For example, the drone 120 may try to stay within a first threshold distance of the target person to ensure a level of image quality captured by the onboard camera 122 (e.g., stay within three meters, two meters, one meter, etc.) until it detects that a portion of the target person is within a second threshold distance (e.g., a hand of the target person is within 0.8 meter, 0.5 meters, 0.2 meters, etc.). Once the drone 120 detects that a portion of the target person (e.g., hand of the target person, foot of the target person, item carried by the target person, etc.) is within the second threshold distance, the drone 120 may move farther away from the target person and/or increase the threshold distance (e.g., increase threshold distance from two meters to three meters). Additionally, once the drone 120 detects that a portion of the target person is within the second threshold distance, the drone 120 may actively evade the portion of the target person to avoid contact between the target person (or an item that the target person is holding/carrying) and the drone 120.

While pursuing a target person, the drone 120 can stream location data (e.g., from an onboard GPS unit) and/or images (e.g., video) from the onboard camera 122 to the computer system 130. Additionally or alternatively, while pursuing a target person, the drone 120 can stream location data (e.g., from an onboard GPS unit) and/or images (e.g., video) from the onboard camera 122 to cloud storage. The computer system 130 can proceed to access the location data and/or the images from the cloud storage.

The drone 120 may continue to pursue a target person until one or more events and/or conditions are detected. For example, the drone 120 may continue to pursue a target person until any of the following occur: the target person drops the package or other item that they stole (e.g., the drone 120 may send location data indicating where the package is located and send the location data to a computing device of the occupant 106, to the computer system 130, and/or to cloud storage); the target person enters a building (e.g., the drone 120 may send location data indicating the location of the building to a device of the occupant 106, to the computer system 130, and/or to cloud storage; the drone 120 may return to the property 102; and/or the drone 120 may stay near the building and monitor the building to see if the target person exits the property); the target person enters a vehicle and departs faster than the drone 120 can travel; the target person travels greater than a threshold distance from the house (e.g., the drone 120 may only pursue a target person up to a set radial distance from the property 102; the radial distance may be dynamic and correspond to the amount of battery life that the drone 120 has remaining); or an emergent condition at the property is detected and has a higher priority than the pursuit (e.g., the computer system 130 detects that another visitor has arrived at the property 102).

In a case where a package is left on the front porch of the property 102 and a person walks up to the property 102, the doorbell camera 112 and/or other cameras of the property 102 will start to record image data (e.g., video) that includes the person. The computer system 130 can use the image data to determine that the person is approaching the property 102, and/or that the person is not known. In response to these determination(s), the computer system 130 can send instructions to the drone 120 to activate, and/or to navigate to a location where it can monitor the person and/or the package. The computer system 130 may generate and send a notification to a computing device of the occupant 106 indicating that an unknown person is approaching the property 102. The notification may include one or more images of the person. The occupant 106 may also have an option to open a live video and/or audio stream to one or more cameras at the property 102, including the doorbell camera 112, the onboard camera 122, and/or one or more other cameras.

Continuing with this example, the image data may also show that the person has taken the package from the front porch of the property. The computer system 130 can analyze the image data to determine that the person has taken the package. In response to this determination, the computer system 130 can generate and send a notification to the occupant 106 indicating that a theft has occurred (e.g., that a package has been stolen, or that a specific package has been stolen). Additionally or alternatively, the computer system 130 may notify local police of the theft. In notifying the local police, the computer system 130 may provide a current location of the person. As the person leaves the property 102, the drone 120 may follow the person, sending a continuous stream of location data and video to the computer system 130 and/or to a centralized server.

Continuing with this example, if the person drops the package in a street (e.g., in response to seeing the drone 120 following them) before entering a vehicle, the drone 120 may circle the vehicle to capture imagery of the make, model, and license plate(s) corresponding to the vehicle. After capturing this information, the drone 120 may navigate to a location where it can guard/monitor the package. The drone 120 can send an indication of the package location and/or an indication that the package has been left to the computer system 130 and/or to a centralized server. In response to receiving the indication of the location of the package and/or the indication the package has been dropped, the computer system 130 can generate and send a notification to the occupant 106 indicating one or more of the final location of the package, that the package has been left by the person, that the person has fled in a vehicle, the information corresponding to the vehicle (e.g., images of the vehicle, an identified make of the vehicle, an identified model of the vehicle, an identified year of the vehicle, license plate number(s) of the vehicle, etc.), etc. The occupant 106 can use this notification to track down the package. Additionally or alternatively, the occupant 106 can use a computing device (e.g., a smart phone) that has access to the location data and/or video data that the drone 120 is streaming to track the location of the drone 120 and, therefore, the location of the package. The computer system 130 (or the drone 120) can also notify the local police of the package being left, of the person fleeing in a vehicle, and/or the information corresponding to the vehicle (e.g., images of the vehicle, an identified make of the vehicle, an identified model of the vehicle, an identified year of the vehicle, license plate number(s) of the vehicle, etc.).

Similarly, if the person enters a vehicle with the package (e.g., in response to seeing the drone 120 following them), the drone 120 may circle the vehicle to capture imagery of the make, model, and license plate(s) corresponding to the vehicle before the person drives away with the package. The drone 120 may also capture the location when the person entered the vehicle with the package prior to driving off. After capturing the vehicle and/or location information, the drone 120 may navigate back to the property 102. Additionally or alternatively, after capturing the vehicle and/or location information, the drone 120 may stay at the location where the person entered the vehicle to identify an initial direction of travel of the vehicle, a road that the vehicle was last seen traveling on, etc.

Continuing the example, if the vehicle drives off, the drone 120 may perform one of the following actions: return to the property 102; remain at the current location while collecting additional information on the navigation of the vehicle (e.g., direction of travel, road that the vehicle is traveling on, etc.); or may start to pursue the vehicle but may stop pursuit in response to the vehicle traveling more than a particular distance or a radial distance from a particular location (e.g., a threshold radial distance from the property 102 which may correspond to the battery life of the drone 120), or the vehicle traveling at speed greater than a particular speed (e.g., greater than 20 mph, 25 mph, 30 mph, etc. which may correspond to a maximum speed of the drone 120). The drone 120 can send an indication of the last known package location and/or an indication that the package has been taken in a vehicle to the computer system 130 and/or to a centralized server. In response to receiving the indication of the location of the package and/or the indication the package has been taken in a vehicle, the computer system 130 can generate and send a notification to the occupant 106 indicating one or more of the last known location of the package, that the package has been driven off with, that the person has fled in a vehicle with the package, the information corresponding to the vehicle (e.g., images of the vehicle, an identified make of the vehicle, an identified model of the vehicle, an identified year of the vehicle, license plate number(s) of the vehicle, etc.), etc. The computer system 130 (or the drone 120) can also notify the local police of the package being driven off with, of the person fleeing in a vehicle with the package, and/or the information corresponding to the vehicle (e.g., images of the vehicle, an identified make of the vehicle, an identified model of the vehicle, an identified year of the vehicle, license plate number(s) of the vehicle, etc.).

In some implementations, the system 100 (e.g., the computer system 130, the smart doorbell 110, and/or the drone 120) will not initiate the drone 120 to pursue a person who has taken a package (or other item) from the property 102 if the person is recognized. For example, if the computer system 130 identifies a person as an occupant of the property 102 or, in some cases, as a family member (or even as a friend) of an occupant of the property 102, then the computer system 130 will refrain from sending instructions to the drone 120 to pursue the person. In recognizing an occupant or a family member of an occupant, the system 100 (e.g., the computer system 130, the smart doorbell 110, and/or the drone 120) can employ one or more techniques. For example, the smart doorbell 110, the drone 120, and/or the computer system 130 can employ of facial detection, e.g., by comparing a captured image of the target person with stored images of occupants and/or family members of occupants. Similarly, the smart doorbell 110, the drone 120, and/or the computer system 130 can employ of voice recognition, e.g., by comparing a captured audio clip of the target person with stored audio clips of occupants and/or family members of occupants.

As another example, the smart doorbell 110, the drone 120, and/or the computer system 130 can employ mobile device/wearable proximity sensor (e.g., a NFC tag, RFIC tag, Bluetooth connection, etc.) to determine if a target person (e.g. a person near the property 102, a person approaching the property 102, a person attempting to enter the property 102, a person who has picked up and/or leaving with a package on the front porch of the property 102, a person who has picked up and/or leaving with an item from the property 102, etc.) is actually an occupant of the property 102. Based on a determination that the target person is an occupant of the property 102, the smart doorbell 110, the drone 120, and/or the computer system 130 can determine that the drone 120 should not pursue the target person.

As another example, the smart doorbell 110, the drone 120, and/or the computer system 130 can use the direction of movement to determine what actions to take with respect to a target person. For example, the computer system 130 may refrain from signaling the drone 120 to track a target person if the target person takes the package inside the property 102. Whereas, had the target person tried to leave the property 102 with the package, the computer system 130 may have sent instructions to the drone 120 to follow the target person.

As another example, the smart doorbell 110, the drone 120, and/or the computer system 130 can employ gesture detection to identify target persons and/or in determining what actions to take with respect to a target person. For example, the occupant 106 may select a specific gesture that the smart doorbell 110 and/or the drone 120 would recognize as a secret code for temporarily disarming the system. Alternatively, explicit disarming could be used to turn off or prevent certain actions, such as pursuit actions using the drone 120. For example, the occupant 106 could disarm the drone-pursuit action via a security system panel of the property 102 and/or through an app of a computing device of the occupant 106 prior to picking up package(s) from the front porch of the property 102. The occupant 106 may disarm the drone-pursuit action by disarming the security system of the property 102, by unlocking the front door of the property 102, by specifically selecting that the action be prevented through an app of a computing device of the occupant 106, etc.

In some implementations, the computer system 130 and/or the drone 120 may collect sensor data and use the sensor data to determine if a visitor of the property 102 and the occupant 106 of the property 102 are already interacting with one another. The sensor data may include, for example, image data and audio data (e.g., collected using sensors of the drone 120, the doorbell camera 112 or other sensors of the smart doorbell 110, etc.). The computer system 130 and/or the drone 120 may use the image data to determine if the visitor and the occupant are near one another. For example, the computer system 130 may assume that the occupant 106 and the visitor are interacting if they are within a threshold distance from one another (e.g., are within 1 meter, 1.5 meters, 2 meters, etc.). Similarly, the computer system 130 and/or the drone 120 may use the audio data to determine if the visitor and the occupant are talking to one another. For example, the computer system 130 may collect audio data using an onboard microphone of the drone 120 and may use speech recognition to determine that occupant 106 and visitor are speaking with one another. Based on determining that the occupant 106 and the visitor are speaking with one another, the computer system 130 may determine that the occupant 106 and the visitor are interacting with one another. In some case, determining that the occupant 106 and the visitor are interacting with one another is based on both image data and audio data.

The actions performed by the system 130 and/or the drone 120 may be dependent upon the determination that the visitor and occupant 106 are interacting with one another. Specifically, in response to determining that the occupant 106 and one or more visitors are already interacting, the drone 120 could learn or assume that a visitor has already being greeted (and, therefore, does not need to be greeted by the drone 120), could choose to leave the visitor for the occupant 106 to handle, and/or learn, based on the interaction (e.g., based on the image data and/or audio data capturing the interaction between the occupant 106 and one or more visitors), that the occupant 106 needs assistance with one or more visitors (e.g., as a result of the activity of the visitor being hostile, the interaction between the visitor and the occupant 106 being hostile, the number of visitors being more than the occupant 106 can greet at a time, etc.). As an example, instead of instructing the drone 120 to notify the occupant 106 of the visitor's arrival and/or to greet the visitor, the computer system 130 may instead have the drone 120 monitor the visitor upon determining that the visitor and the occupant 106 are already interacting.

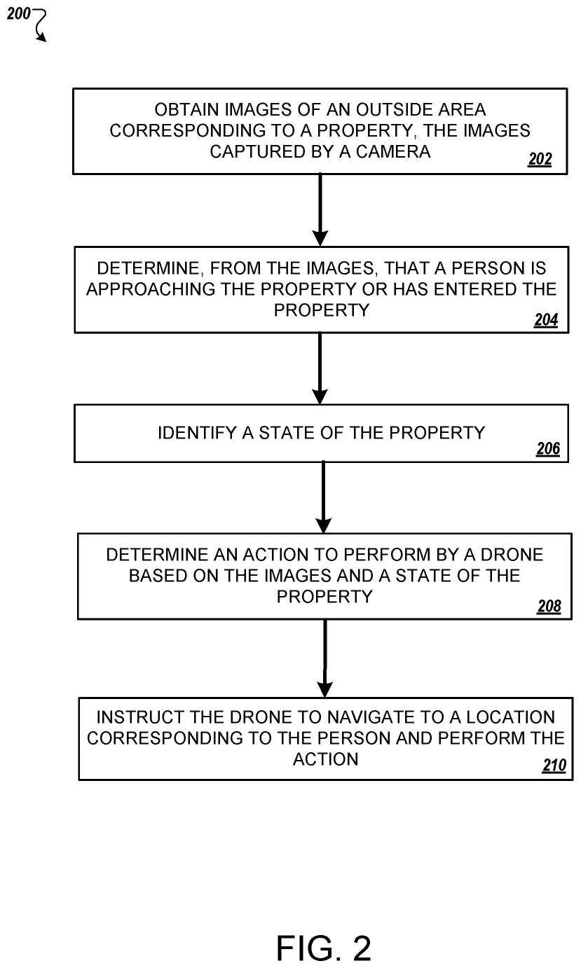

FIG. 2 is a flowchart of an example process 200 for monitoring and managing a property using a drone. The process 200 can be performed, at least in part, using the system 100 described in FIG. 1 or the monitoring system 400 described in FIG. 4.

The process 200 includes obtaining images of an outside area corresponding to a property, the images captured by a camera (202). For example, with respect to FIG. 1, the smart doorbell 110 can obtain the images 116 using the doorbell camera 112. The images 116 may include all or a portion of the front porch of the property 102, all or a portion of the front yard of the property 102, a driveway of the property 102, etc. Similarly, the drone 120 may collect images of the property 102 and/or areas around the property 102 using an onboard camera 122. The images captured using the doorbell camera 112 and/or the onboard camera 122 can be provided to the computer system 130, which can proceed to analyze the images. In some cases, where the drone 120 is part of the smart doorbell 110, the doorbell camera 112 is the onboard camera 122. The images captured using the doorbell camera 112 and/or the onboard camera 122 can be provided to the computer system 130. In some cases, the images are captured from one or more other cameras of the property 102, such as security cameras that monitor outside areas of the property 102 (e.g., front yard, back yard, side yard, front porch, driveway, garage, etc.).

In some cases, the property refers to the area that contains a structure such as an office building, house, apartments, or other dwellings. Accordingly, the property can include the land surrounding the structure. For example, with respect to FIG. 1, the property 102 can include the house as well as the front yard and back yard adjacent to the house.

In some cases, the drone 120 analyzes the images its captures using the onboard camera 122. Similarly, in some cases, the smart doorbell 110 analyzes the images it captures using the doorbell camera 112. For example, the one or more imaging devices can include the smart doorbell 110 installed on the property at a position having a viewpoint of the outside area (e.g., front porch). The one or more cameras include doorbell camera 112 and/or one or more other cameras installed on the property 102 that are electronically connected to the smart doorbell 110 or to the computer system 130. Here, obtaining the images can include using the doorbell camera 112 to capture at least a subset of the images of the outside area of the property 102.

The process 200 includes determining, from the images, that a person is approaching the property or has entered the property (204). For example, with respect to FIG. 1, the computer system 130 can use various imaging techniques to analyze the images 116. As a result of analyzing the images 116, the computer system 130 can determine one or more events occurring at the property 102, and/or conditions of the property 102. For example, as shown in FIG. 1, the computer system 130 can determine that the person 104 is approaching the property 102 and/or is near the property 102.

In some cases, as a result of analyzing the images 116, the computer system 130 may identify the person 104 as an occupant of the property 102, as a family member of an occupant of the property 102, as a friend of an occupant of the property 102, as a co-worker of an occupant of the property 102, as a neighbor of an occupant of the property 102, as a deliveryman who has previously delivered a package at the property 102, as a serviceman who has previously provided a service at the property 102, etc.

The process 200 includes identifying a state of the property (206). The state of the property can suggest or be indicative of what actions the computer system 130 should perform, such as what instructions the computer system 130 should transmit to the drone 120. The computer system 130 can identify the state of the property by evaluating a set of one or more factors. These factors can include control settings, such as the arming state of a security system for the property, a schedule for when friends or other visitors are permitted to visit the property, a schedule when the occupants are expected to be away from the property or expected to be at the property, or a schedule when the occupants are expected to awake or asleep.

These control settings may be predetermined, set or manually changed by the one or more occupants of the property (e.g., a subset of occupants having administrator control) using occupant computing devices in communication with the computer system 130, or dynamically set by the computer system 130 based on the behavior of occupants, feedback from occupants, and/or information from external computing systems (e.g., weather systems; crime reports in the geographic region such as the state, city, or neighborhood where the property 102 is located).

Other factors can include conditions or events detected by the system 130. For example, the computer system 130 may use information such as the location of occupants in the property 102 (e.g., the particular rooms of the property 102 the occupants are located in, whether the occupants are inside the property 102 or in an area outside of the property 102), an identity of the person approaching or having entered the property, the age of the occupants present at the property (e.g., all visitors may be denied access to the property 102 if all the occupants present at the property 102 are children), the state of the occupants themselves such as whether they have been detected as asleep, the time of day or date, whether the sun has set, etc. to identify a state of the property 102.

In determining values for these factors, the computer system 130 may use data obtained from one or more connected devices or external systems. For example, the computer system 130 can use sensor data (e.g., images) obtained from cameras installed on the property 102 to determine locations for each of the occupants at the property 102 and to correctly identify the occupant at each of the locations. The computer system 130 can also use information obtained from external systems and devices. For example, the computer system 130 can request and obtain GPS data from occupant computing devices, and use the obtained GPS data to verify that the occupants of the property 102 are away from the property 102 by comparing the GPS data to a known location of the property 102.

As another example, a factor for determining the state of the property, and ultimately which actions the drone 120 should perform, can include whether the sun has already set. A finding that the sun has already set may suggest that a detected person is less likely to be permitted visitor, e.g., which may increase the likelihood of the drone 120 being instructed to track the detected person, notify the occupant through a message, notify external systems such as police or emergency systems, and/or instruct the person to leave the property. In contrast, a finding that the sun has not already set may suggest that a detected person is more likely to be a permitted visitor, e.g., which may increase the likelihood of the drone 120 being instructed to guide the person to an occupant or particular part of the property, greet the person, and/or open up a line of communication between the person and the occupant (e.g., voice call, text to speech output and speech to text, etc.). The computer system 130 may use image data from the camera 112 to determine whether the sun has set. Alternatively, the computer system 130 may request this information wirelessly from an external time and date system.

The various factors used to determine the state of the property can be organized into different categories or hierarchies. The categories of factors may have particular logical relationships with other categories of factors or with specific factors. Similarly, specific factors may have logical relationships with other particular factors. These relationships may provide for reducing or eliminating the impact of certain factors in the determination of the state of the property based on the value of another factor or category of factor. For example, when the value of one factor in a first category reaches a threshold value, the value of a second factor in a second category should not be used during the computer system 130's calculation the state of the property or the computer system 130 should apply a weight of zero to the second factor before it calculates the state of the property. The logical relationships can also include hierarchies that exist between categories of factors, between particular factors, and/or between categories of factors and particular factors.

The computer system 130 can use these categories and/or logical relationships to determine the state of the property. In more detail, the computer system 130 can look up the logical relationships that exist between a subset of factors that have been identified as having a non-null value. The computer system 130 can proceed to use the extracted logical relationships to identify which factors in the subset of factors should be considered when determining the current state of the property (e.g., by identifying the factors with the highest priority based on hierarchy and/or identifying the factors that take precedence over other, potentially competing, factors), to determine weights that should be applied to the factors in the subset of factors when determining the current state of the property, and/or to identify algorithms that should be used to determine the state of the property.

As an example, some factors may be categorized as property-state-based activity while other factors may be categorized as expected or scheduled activity. The property-state-based activity can include particular events, conditions, or behaviors observed at a property. Specific examples of property-state-based activity factors when a person is approaching a property can include the time of day, whether the sun has set, whether the person is identified as a known person, etc. In contrast, expected or scheduled activity factors include factors that are not based or are not based entirely on observations at the property. For example, expected or scheduled activity factors can include whether an event is scheduled for the current time and/or date, whether an occupant is expected to be away from the property, whether an occupant is expected to be at the property, whether an occupant is expected to be asleep, whether an occupant is expected to be in a particular location at the property, etc.

In certain scenarios, these expected factors (e.g., scheduled factors) may counteract observed factors (e.g., property-state-based factors). For example, typically when a person approaches the property 102 after sunset, the computer system 130 may determine a state of the property that suggests that the person presents a sufficiently high threat to the occupants of the property 102. This state of the property 102 can be used by the computer system 130 to determine one or more actions to take in an effort to mitigate the threat, such as by instructing the drone 120 to turn on and take flight, instructing the drone 120 to track the person, instructing the drone 120 to output an audio message telling the person to leave the property 102, etc. However, if a schedule for the property indicates that an event is scheduled during a time period that coincides with the current time and the event indicates that visitors are welcome, the computer system 130 may determine that the expected factors that provide for the scheduled event counteract the observed factors that provide for the person approaching the property 102 at night. The resulting state of the property 102 determined by the computer system 130 may suggest no threat to the occupants or a reduced threat to the occupants compared to the state if no event was scheduled. As will be discussed in more detail below, in some implementations, observed factors can counteract expected factors.

Each factor or category of factors may correspond to a threat level or range of threat levels. The threat level assigned by the computer system 130 to a particular factor or category of factors may depend on the calculated value for that factor and/or for the factors in a category of factors. The threat level can represent a calculated risk to the occupant(s) based on the activity corresponding to the factors. The threat level can be a numerical value that the computer system 130 compares to different thresholds to determine what actions, if any, should be taken by the system 130. Alternatively, the threat level can correspond to particular thresholds and/or ranges of values. As an example, the computer system 130 may calculate a value that represents the risk that observed events, conditions, or behaviors at the property present to the occupants of the property. This value may be compared to different thresholds that each correspond to a particular threat level and, in some implementations, a different set of actions for the computer system 130 to take. The current threat level may be set by the computer system 130 to the threat level associated with the highest or lowest threshold met.

The threat levels associated with particular factors or categories of factors may be considered by the computer system 130 when determining the state of the property. For example, the threat levels may affect the logical relationships between the factors and/or categories of factors, impact or call for particular weights to be applied to the factors and/or categories of factors, and/or affect the algorithm that is selected by the computer system 130 to determine the state of the property. As an example, based on the current time of day corresponding to a time after sunset in a geographic location where the property is located, the computer system 130 may look up an algorithm that represents the logical relationships between property-state-based factors and scheduled factors during this time period (e.g., between sunset and sunrise). The algorithm may provide that when a value for scheduled events during the time is set to 1 (e.g., indicating that the calendar for the property indicates that the occupants are expecting visitors), then the impact of a factor for a person approaching the property after sunset should be reduced or eliminated in the determination of the state of the property. However, the algorithm may further provide that when the threat level corresponding to property-state-based factors meets or exceeds a particular threat level, then the impact of a factor for a person approaching the property after sunset should be restored or increased and/or the impact of a factor for a scheduled event should be reduced or eliminated.

That is, if the observed activity of the person approaching the property suggests a high enough risk to the occupants of the property, e.g., based on the person being an unknown person, exhibiting suspicious behavior such as attempting to enter through a window or attempting to manipulate objects on the property, the person approaching the property from a suspicious location that diverts from the locations that welcomed visitors typically approach the property from or locations that correspond to where visitors would be expected to approach the property from such as driveways, streets, or sidewalks, then the computer system 130 may take this high risk into account in determining the state of the property to find that the state of the property suggests that the approaching person is threat to the occupants of the property. In this way, the observed factors (e.g., the property-state-based factors) can counteract the expected factors (e.g., scheduled factors).

Determining the state of the property can include the computer system 130 determining a threat level after taking into consideration all relevant factors' impact on the threat level. As an example, an algorithm that used by the computer system 130 to determine the state of the property may provide that a threat level is increased +1 when a person is observed on the property after sunset, that a threat level is decreased −1 when an event permitting visitors is occurring at the time a person is observed on the property, and that a threat level is increased +1 when a person observed on the property is not identified as a known person. If the threat level is first 0 when a person is observed entering the property, the computer system 130 may increase the threat level to 1. After the computer system 130 looks up a schedule for the property and determines that the current time corresponds to an party event where known visitors are welcome, the computer system 130 can lower the threat level back to 0.

The threat level of 0 may represent the state of the property or be used by the computer system 130 in determining the state of the property 102. Based on the threat level being 0, the computer system 130 may instruct the drone 120 to greet the person, verify their identity, and, if verified, guide them to a location on the property 102 that corresponds to the party event. However, if images captured by the camera 122 of the drone 120 indicate that the person is not a known person, the computer system 130 may increase the threat level to 1 and select new actions to perform based on the resulting changes to the state of the property. These new actions can include providing instructions to change the position of the drone 120 with respect to the person (e.g., to add distance between the drone 120 and the person) and instructions for the drone 120 to output a message asking the person why they have entered the property 102. The drone 120 can use its camera 122 and/or an onboard microphone to capture image and audio data of the person and generate a notification that includes captured images, video, and/or audio. The drone 120 may proceed to transmit this notification to a device of the occupant 106.

The computer system 130 can use a variety of techniques to derive the state of the property from the factors listed above. As an example, after determining values for a set of factors (e.g., string such as name of a particular condition or event detected, binary value to represent whether a condition or event has been detected or not, numerical value to represent the number of occupants present at the property, etc.), the computer system 130 may refer to a lookup table and use the values to identify the state of the property. The state of the property may correspond to one or more actions for the drone 120 to perform, or one or more different action options that the computer system 130 can select from for the drone 120 to perform. Alternatively, the determined values may collectively represent the state of the property. In this case, the computer system 130 may apply the values to a lookup table to identify an action or a set of actions for the drone 120 to perform.

As another example, the computer system 130 can use one or more static or machine learning algorithms to identify the state of the property. For example, the computer system 130 can determine values such as numerical values for a set of factors corresponding to the state of the property. The computer system 130 can proceed to provide these values as input to a machine learning model. The output of the machine learning model may be a value that represents the state of the property. The computer system 130 can proceed to apply the output to a lookup table to identify one or more actions for the drone 120 to perform. The machine learning model may have been initially trained using one or more training data sets that specify different sets of factor values and the desired corresponding state of the property. The machine learning model, or a static algorithm, may be updated over time using feedback from the occupants of the property or from other occupants of other properties.

In some cases, the computer system 130 applies different weights to different factor values. The weights can be determined based on preferences or behaviors of the occupants. For example, if an occupant regularly has visitors over after 10:00 pm, the computer system 130 may determine that a weight for the factor of whether the time is between 10:00 pm and 8:00 am (e.g., which would generally factor in against certain drone actions such as guiding a visitor to an occupant of the property, while supporting other drone actions such as generating and transmitting a notification to the occupant or to one or more external systems) should be lower than a predetermined or previous weight for that factor. The weights may also be dynamic based on other events or conditions detected. Continuing the earlier example, if substantially all visitors that the occupant welcomes after 10:00 pm are known persons (e.g., friends or family), then the computer system 130 may determine a first weight for the factor of whether the time is between 10:00 pm and 8:00 am that is lower than a predetermined or previous weight for the factor when a person approaching the property is identified as a known person. However, when a person approaching is instead identified as an unknown person, the computer system 130 may dynamically adjust the weight for the factor such that a second weight, larger than the first weight, is applied to the factor. This second weight may be larger than the first weight, equal to the predetermined or previous weight, or larger than the predetermined or previous weight.

In some cases, identifying the state of the property includes determining whether any occupants of the property are located at the property. For example, with respect to FIG. 1, the computer system 130 may refer to a schedule that indicates that only two occupants of the property 102 are anticipated to be present at the property 102. The computer system 130 may use sensor data, such as image data acquired from one or more cameras installed at the property 102, to verify the presence of the two occupants, verify that the two other occupants are not present, and/or determine locations for the present occupants. Here, determining the action to perform by the drone can include determining the action based on whether any occupants of the property are located at the property. As an example, if no occupants are at the property 102 when the person approaches or enters the property 102, the computer system 130 may avoid providing instructions to the drone 120 to guide the person. Instead, the computer system 130 may select instructions for drone 120 to track the person from a distance (e.g., predetermined distance, variable distance based on different factors such as whether the time of day and the objects/structures in the area, etc.) by keeping the person in field of vision of the camera 122 of the drone 120.

In tracking a person, the drone 120 may capture image data and/or audio data of the person and transmit the image/audio data to the computer system 130, one or more occupant devices, and/or to one or more external systems (e.g., cloud computing server, police system, etc.). The image/audio data may be captured and transmitted by the drone 120 in real-time or near-real-time so as to provide a live video, audio, or audiovisual feed of the person to one or more viewers or listeners.

Continuing this example, if additional factors indicate that the state of the property is particularly suspicious (e.g., a determined threat level meets or exceeds one or more threat value thresholds), then the computer system 130 may determine one or more alternative or additional actions for the drone 120 to perform. These additional factors may include, for example, the computer system 130 determining that the current time is between 12:00 am and 4:00 am, crime data indicates a positive trend of break-ins in the geographic region where the property 102 is located, and/or the computer system 130 failing to identify the person after extracting features of the person (e.g., facial features) and comparing to previously extracted features of known persons (e.g., occupants, family of occupants, and friends). The alternative or additional actions can include actions for the drone 120 to contact one or more police systems, initiate contact with the person and output an audio message that informs the person that they are being monitored, initiate contact with the person and output an audio message that instructs the person to leave the property, initiate contact with the person and output an audio message that informs the person that police are on the way to the home (e.g., even if they have yet to be contacted), and/or initiate contact with the person and output an audio message that informs the person that the occupants are home and are aware of the person's presence.

In some cases, determining whether any occupants of the property are located at the property includes determining that one or more occupants of the property are located at the property. For example, the computer system 130 can use image data obtained from a camera overlooking the backyard of the property 102 to determine that the occupant 106 is located at the property 102. Here, identifying the state of the property can include determining one or more locations of the one or more occupants at the property. For example, the computer system 130 can use data corresponding to the images (e.g., metadata, communication data, etc.) to determine that the images were produced from a camera overlooking the backyard of the property 102. Based on this, the computer system 130 can determine that the occupant 106 is located in the backyard of the property 102. The computer system 130 may further analyze the images to determine an exact location of the occupant, e.g., by identifying a representation of the occupant 106 from the images and comparing the relative location of the representation to one or more landmarks identified in the images. Here, determining the action to perform by the drone can include determining the action based on the one or more locations of the one or more occupant. For example, based on the determination that the occupant 106 is located in the backyard, the computer system 130 may determine that the drone 120 is to guide the person approaching the property 102 to the backyard where the occupant 106 is located.

In some cases, determining the action based on the one or more locations of the one or more occupants includes: based on the one or more locations of the one or more occupants, selecting a location of the one or more locations corresponding to an occupant of the one or more occupants; and determining that the drone is to guide the person to the location of the occupant. As an example, using sensor data, the computer system 130 may determine that there are two occupants at the property 102, a first occupant located in a bedroom of the property 102 and the occupant 106 located in the backyard of the property 102. The computer system 130 may determine a first navigation path from the person to the first occupant and a second navigation path to the occupant 106. Based on the first navigation path being longer than the second navigation path, the computer system 130 may determine that the drone 120 should guide the person to the occupant 106 instead of the first occupant. As another example, based on the first navigation having more turns than the second navigation path and/or having a greater vertical distance than the second navigation path, the computer system 130 can determine that the drone 120 should guide the person to the occupant 106 instead of the first occupant.

Control settings (e.g., permissions) for areas of the property can also factor into to determining which of the occupants the drone 120 should guide the person to. For example, if the first occupant is located in a bedroom and observed behavior of the first occupant (or all occupants of the property 102) indicates that visitors are not permitted in bedroom type rooms and default control settings indicates that visitors are permitted in the backyard (e.g., and have not been manually or intelligently modified), the computer system 130 can determine that the drone 120 is to guide the person to the occupant 106 in the backyard and not to the first occupant in the bedroom of the property 102.

In some cases, determining that the drone is to guide the person to the location of the occupant includes determining that drone is to guide the person instead of performing one or more other actions in response to at least one of the following: based on the images, identifying the person as a previously identified person; based on the images, identifying the person as a visitor of the property; determining that the one or more occupants of the property include an adult occupant and that the occupant is an adult occupant; determining that the location of the occupant is a location in a particular area of the property where permission settings for the property indicate that at least one person is permitted to approach or enter the particular area of the property; and determining that a current time coincides with a set time range (i) for a scheduled event, (ii) when control settings provide that at least one person is permitted to approach or enter the property, or (iii) between sunrise and sunset of a geographic location of the property. For example, if the computer system 130 is unable to identify the person as a previously identified person using the obtained images, the computer system 130 can determine that the drone 120 should track the person using the camera 122 and not guide the person to an occupant of the property 102 or to a particular part of the property. As previously mentioned, in tracking the person, the drone 120 can provide notification to the computer system 130, to one or more occupant devices, and/or to one or more external systems. These notifications may include image data such as images of the person, video of the person, and/or audio of the person. Alternatively, in this situation, the computer system 130 can determine that the drone 120 is to guide the person to location outside of the property 102.

As another example, if the computer system 130 identifies the visitor as an occupant of the property 102, e.g., not a visitor of the property 102, the computer system 130 may determine that the drone 120 is to not leave its base station or is to return to its base station if it was already dispatched (e.g., dispatched previously due to another event or dispatched previously before better images of the person's facial features could be obtained to identify that the person is an occupant).

As another example, if the computer system 130 determines that the one or more occupants of the property include an adult occupant, the computer system 130 can determine that the drone 120 is to guide the person to the adult occupant and not the one or more children occupants. Where all occupants at the property 102 are children occupants, the computer system 130 can determine that the drone 120 is not to guide the person to any of the occupants present at the property 102. Instead, the computer system 130 can determine that the drone 120 should initiate contact with the person to (i) ask them to leave the property 102, (ii) ask them to return to the property 102 at a later time or date when the adult occupants are anticipated to be back at the property 102, and/or (iii) track the person until the leave property 102. In deciding between these options, the computer system 130 may use the determined state of the property and/or observed actions of the person. For example, the computer system 130 may first instruct the drone 120 to ask the person to return to the property 102 at a later time or date. However, if it determined that the person not respond or fails to leave the property 102, the computer system 130 may select one or more other actions to perform that correspond to a new state of the property and/or a heightened threat level. Continuing the earlier example, based on the person not responding to the drone 120's question, the computer system 130 can instruct the drone 120 to instruct the person to leave and to start tracking the person. In tracking the person, the drone 120 may be instructed to move a threshold distance away from the person and/or a threshold height above the person or ground.

If the person fails to leave the property or ignore instructions from the drone 120, the computer system 130 may determine additional actions for the drone 120 to perform. These additional instructions can include, for example, the generation and transmission of emergency notifications to computing devices of the adult occupants and/or children occupants, the automatic locking of smart door locks installed on the property, the enabling of one or more security devices installed on the property 102 (e.g., turn on outside cameras, turn on inside cameras, etc.), and/or the changing of settings of one or more security devices installed on the property (e.g., frequency of image capture, quality of image capture such as increased pixel capture, etc.).

As another example, if the computer system 130 determines that the location of the occupant is a location in a particular area of the property 102 where permission settings for the property indicate that at least one person is permitted to approach or enter the particular area of the property, then the computer system 130 can determine that the drone 120 is to guide the person to this area. For example, the control settings for the property 102 can indicate that visitors are permitted and/or are instructed to be guided to a foyer of a building on the property 102. Based on these control settings, the computer system 130 can generate instructions for the drone 120 to guide the person to the foyer and notify the occupants of the property 102 that (i) the person is being guided to the foyer and/or (ii) the person is located in the foyer.

As another example, if the computer system 130 determines that a current time coincides with a set time range (i) for a scheduled event, (ii) when control settings provide that at least one person is permitted to approach or enter the property 102, or (iii) between sunrise and sunset of a geographic location of the property 102, then the computer system 130 can determine that the drone 120 is to guide the person to a particular location on the property and/or is to greet the person using one or more preselected messages that correspond to a permitted visitor (e.g., welcoming messages).

In some cases, determining whether any occupants of the property are located at the property includes determining that one or more occupants of the property are located at the property; identifying the state of the property includes determining one or more identities of the one or more occupants; and determining the action to perform by the drone includes determining the action based on the one or more identities of the one or more occupants. For example, a factor for determining the state of the property 102 can include an indication of whether the owner of the property 102 or renter of the property 102 is at the property 102. If, for example, the owner of the property 102 is at the property, the computer system 130 can determine that the drone 120 is to guide the person to the owner. That is, in some cases, determining the action based on the one or more identities of the one or more occupants includes, based on the one or more identities, selecting an occupant of the one or more occupants located at the property; and determining that the drone is to guide the person to the location of the occupant based on the identity of the occupant.

In contrast, if the owner of the property 102 is not home and the person corresponds to a schedule visit (e.g., property maintenance, package delivery, etc.) the computer system 130 may either determine that the drone 120 is to guide the person to a location corresponding to the scheduled visit (e.g., location where maintenance is needed, designated package drop-off area, etc.) or that the drone 120 is to inform the person that the owner is not at the property 102 and the visit must be rescheduled.

In some cases, selecting the occupant of the one or more occupants located at the property includes selecting the occupant from the one or more occupants based on at least one of the following: the occupant of the one or more occupants is an adult where at least one other occupant of the one or more occupants is a child; the occupant of the one or more occupants is permanent occupant of the property where at least one other occupant of the one or more occupants is a temporary occupant; and control settings indicates that the occupant of the one or more occupants is preferred to make contact with the person or with all persons over at least one other occupant of the one or more occupants. For example, if the computer system 130 determines that the occupant of the one or more occupants is an adult where at least one other occupant of the one or more occupants is a child, the computer system 130 can determine instructions for the drone 120 to guide the person to the adult occupant.

As another example, if the computer system 130 determines that the occupant of the one or more occupants is permanent occupant of the property where at least one other occupant of the one or more occupants is a temporary occupant, the computer system 130 can determine instructions for the drone 120 to guide the person to the permanent occupant. For example, after identifying the person and determining that they are previously known person, the computer system 130 may look up relationship information between the person and occupants of the property, such as professional relationships (e.g., occupant who invited or scheduled appointment with person), friend relationships, and/or family relationships. Accordingly, the computer system 130 may determine instructions to guide the drone 120 to the occupant who has a friend relationship with the identified person and has the shortest navigation path to the person when compared to navigation paths of other occupants that also have a friend relationship with the person. There may be a hierarchy of relationships that determine or influence what action is taken by the drone. For example, if the computer system 130 determines identifies the person as the mother of a first occupant and the mother-in-law of the second occupant, the computer system 130 can determine instructions for the drone 120 to guide the person to the first occupant based on the closer relationship between the first occupant and the person than the second occupant and the person.

In some cases, identifying the state of the property comprises determining a time or date, and determining the action to perform by the drone comprises determining the action based on the time or date. For example, if the current time corresponds to a time range when a package is anticipated to be delivered, the computer system 130 can generate instructions for the drone 120 to travel to a particular position that has a vantage point of the anticipated package drop-off area.

In some cases, determining the action based on the time or date comprises determining that the drone is to: track the person; generate a notification if the person enters the property or remains on the property; and wirelessly transmit the notification to at least one occupant of the property or an external system. For example, if the current time corresponds to a time range when crime is typically higher in a neighborhood where the property 102 is located, the computer system 130 can generate instructions for the drone 120 to track any person that is determined to be approaching the property 102 or has entered the property 102 during these high crime hours. If the person demonstrates suspicious activity or fails to follow instructions provided by the drone 120, the computer system 130 can generate instructions for the drone 120 to perform additional or different actions that correspond to a heightened threat level (e.g., compared to a default or immediately preceding threat level). As an example, the drone 120 may be instructed to generate and transmit a notification (e.g., to an external emergency services system, or to occupant devices) if it detects that a person has entered the property or remains on the property for more than a threshold period of time.

In some cases, determining that the drone is to track the person includes: based on the images, determining that the person is not an occupant of the property; and determining to track the person in response to a determination that (i) the current time or date corresponds to a set time or date when visitors are not permitted to enter the property or (ii) the current time or date does not intersect one or more time ranges when visitors are permitted to enter the property. For example, continuing the earlier example, the control settings for the property 102 may indicates that no visitors are permitted between the hours of 12:00 am and 4:00 am. If the obtained images indicates that the person is not an occupant of the property 102 (e.g., using image recognition techniques such as facial recognition), the computer system 130 can generate instructions for the drone 120 to track the person by (i) keeping the person in a field of view of the camera 122, (ii) maintaining a threshold distance between the drone 120 and the person, and/or (iii) maintaining a threshold height between the drone 120 and the person or between the drone 120 and the ground.

In some cases, identifying the state of the property includes using the images to determine an identity of the person; and determining the action to perform by the drone includes determining an action to perform by the drone based on the identity of the person. For example, based on the computer system 130 identifying the person as a known friend, the computer system 130 may update the state of the property so that a factor corresponding to the identity of the person is added or updated (e.g., may have previously reflected that the person was unknown). After this, the computer system 130 can update the state of the property and, based on the changes to the state of the property, determine one or more different or additional actions for the drone 120 to perform. For example, if the person could not first be identified with the obtained images, the computer system 130 may have instructed the drone 120 to track the person and obtain additional images of the person to transmit to the computer system 130. The computer system 130 may use these new images to determine that the person is actually a known friend. Based on this determination, the computer system 130 may determine that the drone 120 is to stop tracking the person, is to approach the person, and is to greet the person using a predetermine or partially predetermined (e.g., some fields such as the name for the person are automatically filled in) greeting for friends or for this specific friend using one or more onboard speakers of the drone 120.

In some cases, identifying the state of the property includes using the images to determine that the person is a newly identified person; and determining the action to perform by the drone includes determining instructions to have the drone track the person until they leave the property or change trajectory so that their new trajectory does not intersect at least a portion of the property. For example, based on the computer system 130 identifying the person as an unknown person, the computer system 130 may update the state of the property so that a factor corresponding to the identity of the person is added or updated (e.g., may have previously reflected that the person was unknown). After this, the computer system 130 can update the state of the property and, based on the changes to the state of the property, determine one or more different or additional actions for the drone 120 to perform. For example, if the person could not first be identified with the obtained images, the computer system 130 may have instructed the drone 120 to track the person and obtain additional images of the person to transmit to the computer system 130. The computer system 130 may use these new images to verify that the person is an unknown person. Based on this determination, the computer system 130 may determine that the drone 120 is to continue tracking the person and, from a threshold distance, instruct the person to leave the property using one or more onboard speakers of the drone 120.

In some cases, obtaining the images includes: based on the state of the property, determining one or more triggering events; detecting a triggering event of the one or more triggering events; and in response to detecting the triggering event, obtaining the images using the one or more imaging devices. For example, based on the state of the property indicating a first threat level above a second threat level, the computer system 130 can generate instructions to activate the doorbell camera 112 and transmit them to the smart doorbell 110. In response to receiving the instructions, the smart doorbell 110 can use the doorbell camera 112 to acquire image data that can be processed at the smart doorbell 110 and/or transmitted to the computer system 130 for further processing or analysis.

In some cases, obtaining the images includes: based on the state of the property, activating the one or more imaging devices; and, after activating the one or more imaging devices, obtaining the images using the one or more imaging devices. For example, the smart doorbell 110 can include a low-power motion detector. In response to detecting motion, the smart doorbell 110 can transmit a notification of the motion detection to the computer system 130 and/or turn on the doorbell camera 112 and start taking images or recording video. In response to the motion detection, the computer system 130 can update the state of the property to reflect the detected motion and, based on the new state of the property, instruct the smart doorbell 110 to turn on the doorbell camera 112 and acquiring image data and/or instruct one or more other security devices (e.g., other imaging devices) to turn on and start collecting sensor data.

The process 200 includes determining an action to perform by a drone based on the images and a state of the property (208). For example, with respect to FIG. 1, the computer system 130 may send instructions to the drone 120 to activate the drone 120 in response to detecting that the person 104 is approaching and/or near the property 102. The instructions activating the drone 120 may include a command to turn the drone 120 on, to have the drone 120 take flight, and to guide the drone 120 outside to a position where it can view the person 104 and/or the outside area of the property 102 (e.g., the front door, the front porch, the front yard, etc.). Additionally or alternatively, in response to detecting that the person 104 is approaching and/or near the property 102, the computer system 130 may send the instructions 134 to the drone 120 instructing the drone 120 to guide the person 104 to the back yard where the occupant 106 is located. The instructions 134 may also (or alternatively) include instructions for the drone 120 to greet the person 104, e.g., to output one or more prerecorded messages using an onboard speaker.

As an example, the computer system 130 may send the instructions 134 in response to identifying the person 104 as a known family member of the occupant 106, identifying the person 104 as a known friend of the occupant 106, determining that the person 104 is a scheduled visitor (e.g., based on the arrival time matching a scheduled arrival time or being within a threshold time of the scheduled arrival time, such as within fifteen minutes of the scheduled arrival time), receiving instructions from a computing device of the occupant 106 providing that the person 104 should be guided to the occupant 106, or the visitor correctly reciting a passcode (e.g., a passcode set by the occupant 106 and given to deliverymen, servicemen, short term rental guests, friends, family members, etc.).

In some cases, the drone 120 may perform additional or alternative actions. For example, as described above, the drone 120 may perform one or more of the following actions: output one or more prerecorded messages of the occupant 106 (e.g., recorded greetings, recorded warnings, etc.) using the speaker of the drone 120; record and/or stream audio of the person 104; record and/or stream video data of the person 104; generate and/or send a notification to a computing device of the occupant 106 indicating that the person 104 has arrived at the property 102; open up a line of communication between the person 104 and the occupant 106 using a computing device of the occupant 106, and the speaker and microphone of the drone 120; pretend to open up a line of communication between the person 104 and the occupant 106 (e.g., when the occupant 106 is not home and the person 104 is suspicious, when the occupant 106 is sleeping and the person 104 is suspicious, etc.); notify authorities (e.g., the local police) of the person 104 acting suspiciously near the property 102; etc.

As another example, an additional or alternative action can include the drone 120 navigating to the occupant 106. Specifically, the drone 120 may navigate to the occupant 106 in response to determining that the person 104 is approaching the property 102 and/or has arrived at the property 102. The drone 120 may navigate to the occupant 106 after failing to get the occupant 106's attention in one or more other ways. For example, upon detecting the person 104 approaching the property 102 and/or having arrived at the property 102, the drone 120 may send a notification to the occupant 106 and may wait for an acknowledgement (e.g., a read receipt) of the notification or a response to the notification, or may request an acknowledgement (e.g., a read receipt) of the notification or a response to the notification. If no acknowledgement or response is received after, for example, a predetermined amount of time (e.g., ten seconds, thirty seconds, one minute, etc.), the drone 120 may navigate to the occupant 106 to get the occupant 106's attention and/or to notify the occupant 106 of the arrival or imminent arrival of the person 104 at the property 102 (e.g., using an onboard speaker of the drone 120).

With respect to FIG. 1, the actions to be performed by the drone 120 can be based on the state of the property 102. That is, the actions to be performed by the drone 120 can be based on the events/conditions identified by the computer system 130. That is, in the example of FIG. 1, the action to have the drone 120 guide the person 104 to the back yard where the occupant 106 is located can be based on the event that the person 104 is approaching the property 102, the condition that the person 104 has been recognized as a friend of the occupant 106, the condition that the current time being a time when visitors are permitted at the property 102, and/or the condition that the occupant 106 is presently located in the back yard of the property 102.

In some cases, determining the action includes determining to communicate with the person by the drone using communication parameters selected based on at least one of the state of the property and the images; and instructing the drone to perform the action includes instructing the drone to communicate with the person using the communication parameters. For example, the computer system 130 can apply a value that represents the state of the property to a lookup table to retrieve the communication parameters that the drone 120 is to use when communicating with the person. These communication parameters can include, for example, a preselected message based on at least one of the state of the property and the images, a level of formality based on at least one of the state of the property and the images, a level of aggression based on at least one of the state of the property and the images, an indication of whether information describing the state of the property is to be communicated to the person based on at least one of the state of the property and the images, an indication of whether the drone is to provide false information describing the state of the property to the person based on at least one of the state of the property and the images, and/or an indication of whether a line of communication between one or more occupants of the property and the person is to be opened.

As an example, if the identified state of the property corresponds with a high threat level (e.g., higher than one or more other threat levels based on an overall value assigned to the state of the property), the computer system 130 may determine that the drone 120 should use output speakers to inform the person that the police have been called. In some cases, this message may be a bluff to dissuade the person from remaining on the property, from continuing to approach the property, and/or from taking anything from the property.

The process 200 includes instructing the drone to navigate to the person and perform the action (210). For example, with respect to FIG. 1, the computer system 130 may send an instruction to the drone 120 to navigate to a location where it can view the person 104 and/or the outside area. Specifically, the drone 120 may be instruction to navigate to a location that is at least a threshold distance away from the person 104. The drone 120 may be instructed to position itself (or may determine to position itself) such that the person 104 and the outside area (e.g., the front door, the front porch, or the front yard of the property 102)—or portion of the outside area—are in the field of view of the onboard camera 122.

In some cases, if the person 104 moves from their current location, the drone 120 can track the person 104. The drone 120 may only start to track the person 104 if the drone 120 (or the computer system 130) determines that the person 104 performed a suspicious action, such as taking a package from the property 102, damaging the property 102, taking another item from the property 102, etc.

In some cases, navigating to the person includes navigating to an area in the immediate vicinity of the person. For example, the computer system 130 may instruct the drone 120 to navigate to a location that is 0.5-2 m from the person and provide a greeting.

In some cases, navigating to the person includes navigating to an position that provides a vantage point of the person. For example, the drone 120 may receive instructions to travel to a position that allows the person to be in a field of view of the camera 122 of the drone 120.

In some cases, navigating to the person includes navigating to a position that is a threshold overall distance from the person, a threshold horizontal distance the person, and/or a threshold vertical distance from the person or the ground. For example, the drone 120 may be instructed to track the person and navigate to them by traveling to a position that 3.0 m distance from them and 4.0 m distance from the ground.

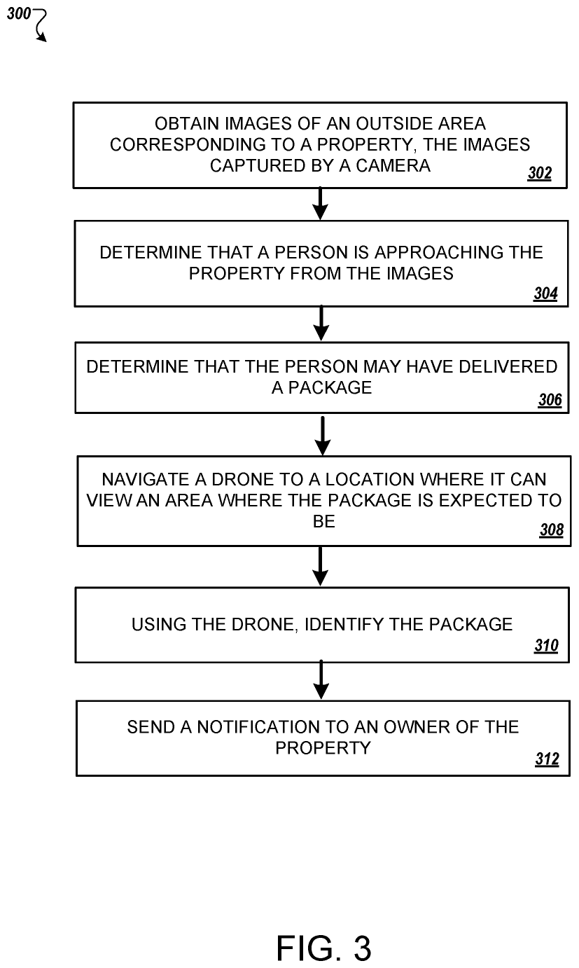

FIG. 3 is a flowchart of an example process 300 for monitoring and managing a property using a drone. The process 300 can be performed, at least in part, using the system 100 described in FIG. 1 or the monitoring system 400 described in FIG. 4.

The process 300 includes obtaining images of an outside area corresponding to a property, the images captured by a camera (302). For example, with respect to FIG. 1, the smart doorbell 110 can obtain the images 116 using the doorbell camera 112. The images 116 may include all or a portion of the front porch of the property 102, all or a portion of the front yard of the property 102, a driveway of the property 102, etc. Similarly, the drone 120 may collect images of the property 102 and/or areas around the property 102 using an onboard camera 122. The images captured using the doorbell camera 112 and/or the onboard camera 122 can be provided to the computer system 130, which can proceed to analyze the images. In some cases, where the drone 120 is part of the smart doorbell 110, the doorbell camera 112 is the onboard camera 122. The images captured using the doorbell camera 112 and/or the onboard camera 122 can be provided to the computer system 130. In some cases, the images are captured from one or more other cameras of the property 102, such as security cameras that monitor outside areas of the property 102 (e.g., front yard, back yard, side yard, front porch, driveway, garage, etc.).

In some cases, the drone 120 analyzes the images its captures using the onboard camera 122. Similarly, in some cases, the smart doorbell 110 analyzes the images it captures using the doorbell camera 112. For example, the one or more imaging devices can include the smart doorbell 110 installed on the property at a position having a viewpoint of the outside area (e.g., front porch). The one or more cameras include doorbell camera 112 and/or one or more other cameras installed on the property 102 that are electronically connected to the smart doorbell 110 or to the computer system 130. Here, obtaining the images can include using the doorbell camera 112 to capture at least a subset of the images of the outside area of the property 102.

The process 300 includes determining that a person is approaching the property from the images (304). For example, with respect to FIG. 1, the computer system 130 can use various imaging techniques to analyze the images 116. As a result of analyzing the images 116, the computer system 130 can determine one or more events occurring at the property 102, and/or conditions of the property 102. For example, as shown in FIG. 1, the computer system 130 can determine that the person 104 is approaching the property 102 and/or is near the property 102.

In some cases, as a result of analyzing the images 116, the computer system 130 may identify the person 104 as an occupant of the property 102, as a family member of an occupant of the property 102, as a friend of an occupant of the property 102, as a co-worker of an occupant of the property 102, as a neighbor of an occupant of the property 102, as a deliveryman who has previously delivered a package at the property 102, as a serviceman who has previously provided a service at the property 102, etc.

The process 300 includes determining that the person may have delivered a package (306). For example, with respect to FIG. 1, the computer system 130 can use images obtained from the doorbell camera 112, the onboard camera 122, and/or other cameras of the property 102 showing the person 104 carrying an item that might be a package in determining that the person 104 is about to deliver a package. Similarly, the computer system 130 can use images obtained from the doorbell camera 112, the onboard camera 122, and/or other cameras of the property 102 showing the person 104 putting down an item that might be a package in determining that the person 104 has delivered a package.

The computer system 130 may also use additional information to determine that a package was delivered and/or to confirm that a package was delivered. For example, if the current time is within a threshold time (e.g., ten minutes, fifteen minutes, thirty minutes, etc.) of when a package is expected to be delivered, the computer system 130 may determine/confirm that the person 104 delivered the package. Similarly, if the current time is in a time range of when a package is expected to be delivered, the computer system 130 may determine/confirm that the person 104 delivered the package. As another example, the computer system 130 may use a determination that the facial features of the person 104 match that of a person who had previously delivered a package to the property 102 to determine/confirm that that the person 104 delivered a package.

The process 300 includes navigating a drone to a location where it can view an area where the package is expected to be (308). For example, with respect to FIG. 1, the computer system 130 can send instructions to the drone 120 providing that the drone 120 should navigate to a location where it can view an area where the package is expected to be. The instructions may include a location of an item that is thought to be a package, or a location where packages are typically dropped off at (e.g., the front porch of the property 102). The instructions may additionally or alternatively include a specific location where the drone 120 should navigate to. Alternatively, the drone 120 determines the specific location based on the location of the item that might be a package, and/or based on the area where packages are typically dropped off at. The instructions may additionally or alternatively include a position for the drone 120 (or the position of the onboard camera 122) such as to place the item that might be a package and/or the area where packages are typically dropped off at into the field of view of the onboard camera 122.

The process 300 includes identifying the package using the drone (310). For example, with respect to FIG. 1, the drone 120 may use its onboard camera 122 to capture one or more images of the item that is might be a package, and/or of an area where packages are typically dropped off at. The drone 120 may send these images to the computer system 130 for analysis (or may analyze the images itself). In analyzing the images, the computer system 130 (or the drone 120) may identify a package in the images. The computer system 130 (or the drone 120) may use this information to confirm that a package was delivered.

The process 300 includes sending a notification to an owner of the property (312). For example, with respect to FIG. 1, the computer system 130 sends a notification to a computing device of the occupant 106 in response to confirming that a package was delivered using images captured from the onboard camera 122. The notification can include an indication that a package was delivered, and/or an indication of the specific package that was delivered (e.g., based on one or more of information printed on the shipping label of the package, a schedule indicating that a particular package was expected to be delivered at or around the current time, etc.). The notification may include a picture of package, such as, for example, an image of the shipping label. Additionally or alternatively, the drone 120 can send a notification directly to a computing device of the occupant 106 in response to confirming that a package was delivered using images captured from the onboard camera 122.

FIG. 4 is a diagram illustrating an example of a home monitoring system 400. The monitoring system 400 includes a network 405, a control unit 410, one or more user devices 440 and 450, a monitoring server 460, and a central alarm station server 470. In some examples, the network 405 facilitates communications between the control unit 410, the one or more user devices 440 and 450, the monitoring server 460, and the central alarm station server 470.

The network 405 is configured to enable exchange of electronic communications between devices connected to the network 405. For example, the network 405 may be configured to enable exchange of electronic communications between the control unit 410, the one or more user devices 440 and 450, the monitoring server 460, and the central alarm station server 470. The network 405 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 405 may include multiple networks or subnetworks, each of which may include, for example, a wired or wireless data pathway. The network 405 may include a circuit-switched network, a packet-switched data network, or any other network able to carry electronic communications (e.g., data or voice communications). For example, the network 405 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 405 may include one or more networks that include wireless data channels and wireless voice channels. The network 405 may be a wireless network, a broadband network, or a combination of networks including a wireless network and a broadband network.

The control unit 410 includes a controller 412 and a network module 414. The controller 412 is configured to control a control unit monitoring system (e.g., a control unit system) that includes the control unit 410. In some examples, the controller 412 may include a processor or other control circuitry configured to execute instructions of a program that controls operation of a control unit system. In these examples, the controller 412 may be configured to receive input from sensors, flow meters, or other devices included in the control unit system and control operations of devices included in the household (e.g., speakers, lights, doors, etc.). For example, the controller 412 may be configured to control operation of the network module 414 included in the control unit 410.

The network module 414 is a communication device configured to exchange communications over the network 405. The network module 414 may be a wireless communication module configured to exchange wireless communications over the network 405. For example, the network module 414 may be a wireless communication device configured to exchange communications over a wireless data channel and a wireless voice channel. In this example, the network module 414 may transmit alarm data over a wireless data channel and establish a two-way voice communication session over a wireless voice channel. The wireless communication device may include one or more of a LTE module, a GSM module, a radio modem, cellular transmission module, or any type of module configured to exchange communications in one of the following formats: LTE, GSM or GPRS, CDMA, EDGE or EGPRS, EV-DO or EVDO, UMTS, or IP.

The network module 414 also may be a wired communication module configured to exchange communications over the network 405 using a wired connection. For instance, the network module 414 may be a modem, a network interface card, or another type of network interface device. The network module 414 may be an Ethernet network card configured to enable the control unit 410 to communicate over a local area network and/or the Internet. The network module 414 also may be a voice band modem configured to enable the alarm panel to communicate over the telephone lines of Plain Old Telephone Systems (POTS).

The control unit system that includes the control unit 410 includes one or more sensors. For example, the monitoring system may include multiple sensors 420. The sensors 420 may include a lock sensor, a contact sensor, a motion sensor, or any other type of sensor included in a control unit system. The sensors 420 also may include an environmental sensor, such as a temperature sensor, a water sensor, a rain sensor, a wind sensor, a light sensor, a smoke detector, a carbon monoxide detector, an air quality sensor, etc. The sensors 420 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health-monitoring sensor can be a wearable sensor that attaches to a user in the home. The health-monitoring sensor can collect various health data, including pulse, heart rate, respiration rate, sugar or glucose level, bodily temperature, or motion data.

The sensors 420 can also include a radio-frequency identification (RFID) sensor that identifies a particular article that includes a pre-assigned RFID tag.

The control unit 410 communicates with the home automation controls 422 and a camera 430 to perform monitoring. The home automation controls 422 are connected to one or more devices that enable automation of actions in the home. For instance, the home automation controls 422 may be connected to one or more lighting systems and may be configured to control operation of the one or more lighting systems. In addition, the home automation controls 422 may be connected to one or more electronic locks at the home and may be configured to control operation of the one or more electronic locks (e.g., control Z-Wave locks using wireless communications in the Z-Wave protocol). Further, the home automation controls 422 may be connected to one or more appliances at the home and may be configured to control operation of the one or more appliances. The home automation controls 422 may include multiple modules that are each specific to the type of device being controlled in an automated manner. The home automation controls 422 may control the one or more devices based on commands received from the control unit 410. For instance, the home automation controls 422 may cause a lighting system to illuminate an area to provide a better image of the area when captured by a camera 430.

The camera 430 may be a video/photographic camera or other type of optical sensing device configured to capture images. For instance, the camera 430 may be configured to capture images of an area within a building or home monitored by the control unit 410. The camera 430 may be configured to capture single, static images of the area and also video images of the area in which multiple images of the area are captured at a relatively high frequency (e.g., thirty images per second). The camera 430 may be controlled based on commands received from the control unit 410.

The camera 430 may be triggered by several different types of techniques. For instance, a Passive Infra-Red (PIR) motion sensor may be built into the camera 430 and used to trigger the camera 430 to capture one or more images when motion is detected. The camera 430 also may include a microwave motion sensor built into the camera and used to trigger the camera 430 to capture one or more images when motion is detected. The camera 430 may have a “normally open” or “normally closed” digital input that can trigger capture of one or more images when external sensors (e.g., the sensors 420, PIR, door/window, etc.) detect motion or other events. In some implementations, the camera 430 receives a command to capture an image when external devices detect motion or another potential alarm event. The camera 430 may receive the command from the controller 412 or directly from one of the sensors 420.

In some examples, the camera 430 triggers integrated or external illuminators (e.g., Infra-Red, Z-wave controlled “white” lights, lights controlled by the home automation controls 422, etc.) to improve image quality when the scene is dark. An integrated or separate light sensor may be used to determine if illumination is desired and may result in increased image quality.

The camera 430 may be programmed with any combination of time/day schedules, system “arming state”, or other variables to determine whether images should be captured or not when triggers occur. The camera 430 may enter a low-power mode when not capturing images. In this case, the camera 430 may wake periodically to check for inbound messages from the controller 412. The camera 430 may be powered by internal, replaceable batteries if located remotely from the control unit 410. The camera 430 may employ a small solar cell to recharge the battery when light is available. Alternatively, the camera 430 may be powered by the controller 412's power supply if the camera 430 is co-located with the controller 412.

In some implementations, the camera 430 communicates directly with the monitoring server 460 over the Internet. In these implementations, image data captured by the camera 430 does not pass through the control unit 410 and the camera 430 receives commands related to operation from the monitoring server 460.

The system 400 also includes thermostat 434 to perform dynamic environmental control at the home. The thermostat 434 is configured to monitor temperature and/or energy consumption of an HVAC system associated with the thermostat 434, and is further configured to provide control of environmental (e.g., temperature) settings. In some implementations, the thermostat 434 can additionally or alternatively receive data relating to activity at a home and/or environmental data at a home, e.g., at various locations indoors and outdoors at the home. The thermostat 434 can directly measure energy consumption of the HVAC system associated with the thermostat, or can estimate energy consumption of the HVAC system associated with the thermostat 434, for example, based on detected usage of one or more components of the HVAC system associated with the thermostat 434. The thermostat 434 can communicate temperature and/or energy monitoring information to or from the control unit 410 and can control the environmental (e.g., temperature) settings based on commands received from the control unit 410.

In some implementations, the thermostat 434 is a dynamically programmable thermostat and can be integrated with the control unit 410. For example, the dynamically programmable thermostat 434 can include the control unit 410, e.g., as an internal component to the dynamically programmable thermostat 434. In addition, the control unit 410 can be a gateway device that communicates with the dynamically programmable thermostat 434. In some implementations, the thermostat 434 is controlled via one or more home automation controls 422.

A module 437 is connected to one or more components of an HVAC system associated with a home, and is configured to control operation of the one or more components of the HVAC system. In some implementations, the module 437 is also configured to monitor energy consumption of the HVAC system components, for example, by directly measuring the energy consumption of the HVAC system components or by estimating the energy usage of the one or more HVAC system components based on detecting usage of components of the HVAC system. The module 437 can communicate energy monitoring information and the state of the HVAC system components to the thermostat 434 and can control the one or more components of the HVAC system based on commands received from the thermostat 434.

In some examples, the system 400 further includes one or more robotic devices 490. The robotic devices 490 may be any type of robots that are capable of moving and taking actions that assist in home monitoring. For example, the robotic devices 490 may include drones that are capable of moving throughout a home based on automated control technology and/or user input control provided by a user. In this example, the drones may be able to fly, roll, walk, or otherwise move about the home. The drones may include helicopter type devices (e.g., quad copters), rolling helicopter type devices (e.g., roller copter devices that can fly and roll along the ground, walls, or ceiling) and land vehicle type devices (e.g., automated cars that drive around a home). In some cases, the robotic devices 490 may be devices that are intended for other purposes and merely associated with the system 400 for use in appropriate circumstances. For instance, a robotic vacuum cleaner device may be associated with the monitoring system 400 as one of the robotic devices 490 and may be controlled to take action responsive to monitoring system events.

In some examples, the robotic devices 490 automatically navigate within a home. In these examples, the robotic devices 490 include sensors and control processors that guide movement of the robotic devices 490 within the home. For instance, the robotic devices 490 may navigate within the home using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 490 may include control processors that process output from the various sensors and control the robotic devices 490 to move along a path that reaches the desired destination and avoids obstacles. In this regard, the control processors detect walls or other obstacles in the home and guide movement of the robotic devices 490 in a manner that avoids the walls and other obstacles.

In addition, the robotic devices 490 may store data that describes attributes of the home. For instance, the robotic devices 490 may store a floorplan and/or a three-dimensional model of the home that enables the robotic devices 490 to navigate the home. During initial configuration, the robotic devices 490 may receive the data describing attributes of the home, determine a frame of reference to the data (e.g., a home or reference location in the home), and navigate the home based on the frame of reference and the data describing attributes of the home. Further, initial configuration of the robotic devices 490 also may include learning of one or more navigation patterns in which a user provides input to control the robotic devices 490 to perform a specific navigation action (e.g., fly to an upstairs bedroom and spin around while capturing video and then return to a home charging base). In this regard, the robotic devices 490 may learn and store the navigation patterns such that the robotic devices 490 may automatically repeat the specific navigation actions upon a later request.

In some examples, the robotic devices 490 may include data capture and recording devices. In these examples, the robotic devices 490 may include one or more cameras, one or more motion sensors, one or more microphones, one or more biometric data collection tools, one or more temperature sensors, one or more humidity sensors, one or more air flow sensors, and/or any other types of sensors that may be useful in capturing monitoring data related to the home and users in the home. The one or more biometric data collection tools may be configured to collect biometric samples of a person in the home with or without contact of the person. For instance, the biometric data collection tools may include a fingerprint scanner, a hair sample collection tool, a skin cell collection tool, and/or any other tool that allows the robotic devices 490 to take and store a biometric sample that can be used to identify the person (e.g., a biometric sample with DNA that can be used for DNA testing).

In some implementations, the robotic devices 490 may include output devices. In these implementations, the robotic devices 490 may include one or more displays, one or more speakers, and/or any type of output devices that allow the robotic devices 490 to communicate information to a nearby user.

The robotic devices 490 also may include a communication module that enables the robotic devices 490 to communicate with the control unit 410, each other, and/or other devices. The communication module may be a wireless communication module that allows the robotic devices 490 to communicate wirelessly. For instance, the communication module may be a Wi-Fi module that enables the robotic devices 490 to communicate over a local wireless network at the home. The communication module further may be a 900 MHz wireless communication module that enables the robotic devices 490 to communicate directly with the control unit 410. Other types of short-range wireless communication protocols, such as Bluetooth, Bluetooth LE, Z-wave, Zigbee, etc., may be used to allow the robotic devices 490 to communicate with other devices in the home. In some implementations, the robotic devices 490 may communicate with each other or with other devices of the system 400 through the network 405.

The robotic devices 490 further may include processor and storage capabilities. The robotic devices 490 may include any suitable processing devices that enable the robotic devices 490 to operate applications and perform the actions described throughout this disclosure. In addition, the robotic devices 490 may include solid-state electronic storage that enables the robotic devices 490 to store applications, configuration data, collected sensor data, and/or any other type of information available to the robotic devices 490.

The robotic devices 490 are associated with one or more charging stations. The charging stations may be located at predefined home base or reference locations in the home. The robotic devices 490 may be configured to navigate to the charging stations after completion of tasks needed to be performed for the monitoring system 400. For instance, after completion of a monitoring operation or upon instruction by the control unit 410, the robotic devices 490 may be configured to automatically fly to and land on one of the charging stations. In this regard, the robotic devices 490 may automatically maintain a fully charged battery in a state in which the robotic devices 490 are ready for use by the monitoring system 400.

The charging stations may be contact based charging stations and/or wireless charging stations. For contact based charging stations, the robotic devices 490 may have readily accessible points of contact that the robotic devices 490 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 490 may charge through a wireless exchange of power. In these cases, the robotic devices 490 need only locate themselves closely enough to the wireless charging stations for the wireless exchange of power to occur. In this regard, the positioning needed to land at a predefined home base or reference location in the home may be less precise than with a contact based charging station. Based on the robotic devices 490 landing at a wireless charging station, the wireless charging station outputs a wireless signal that the robotic devices 490 receive and convert to a power signal that charges a battery maintained on the robotic devices 490.

In some implementations, each of the robotic devices 490 has a corresponding and assigned charging station such that the number of robotic devices 490 equals the number of charging stations. In these implementations, the robotic devices 490 always navigate to the specific charging station assigned to that robotic device. For instance, a first robotic device may always use a first charging station and a second robotic device may always use a second charging station.

In some examples, the robotic devices 490 may share charging stations. For instance, the robotic devices 490 may use one or more community charging stations that are capable of charging multiple robotic devices 490. The community charging station may be configured to charge multiple robotic devices 490 in parallel. The community charging station may be configured to charge multiple robotic devices 490 in serial such that the multiple robotic devices 490 take turns charging and, when fully charged, return to a predefined home base or reference location in the home that is not associated with a charger. The number of community charging stations may be less than the number of robotic devices 490.

In addition, the charging stations may not be assigned to specific robotic devices 490 and may be capable of charging any of the robotic devices 490. In this regard, the robotic devices 490 may use any suitable, unoccupied charging station when not in use. For instance, when one of the robotic devices 490 has completed an operation or is in need of battery charge, the control unit 410 references a stored table of the occupancy status of each charging station and instructs the robotic device to navigate to the nearest charging station that is unoccupied.

The system 400 further includes one or more integrated security devices 480. The one or more integrated security devices may include any type of device used to provide alerts based on received sensor data. For instance, the one or more control units 410 may provide one or more alerts to the one or more integrated security input/output devices 480. Additionally, the one or more control units 410 may receive one or more sensor data from the sensors 420 and determine whether to provide an alert to the one or more integrated security input/output devices 480.

The sensors 420, the home automation controls 422, the camera 430, the thermostat 434, and the integrated security devices 480 may communicate with the controller 412 over communication links 424, 426, 428, 432, 438, and 484. The communication links 424, 426, 428, 432, 438, and 484 may be a wired or wireless data pathway configured to transmit signals from the sensors 420, the home automation controls 422, the camera 430, the thermostat 434, and the integrated security devices 480 to the controller 412. The sensors 420, the home automation controls 422, the camera 430, the thermostat 434, and the integrated security devices 480 may continuously transmit sensed values to the controller 412, periodically transmit sensed values to the controller 412, or transmit sensed values to the controller 412 in response to a change in a sensed value.

The communication links 424, 426, 428, 432, 438, and 484 may include a local network. The sensors 420, the home automation controls 422, the camera 430, the thermostat 434, and the integrated security devices 480, and the controller 412 may exchange data and commands over the local network. The local network may include 802.11 “Wi-Fi” wireless Ethernet (e.g., using low-power Wi-Fi chipsets), Z-Wave, Zigbee, Bluetooth, “Homeplug” or other “Powerline” networks that operate over AC wiring, and a Category 5 (CAT5) or Category 6 (CAT6) wired Ethernet network. The local network may be a mesh network constructed based on the devices connected to the mesh network.

The monitoring server 460 is an electronic device configured to provide monitoring services by exchanging electronic communications with the control unit 410, the one or more user devices 440 and 450, and the central alarm station server 470 over the network 405. For example, the monitoring server 460 may be configured to monitor events generated by the control unit 410. In this example, the monitoring server 460 may exchange electronic communications with the network module 414 included in the control unit 410 to receive information regarding events detected by the control unit 410. The monitoring server 460 also may receive information regarding events from the one or more user devices 440 and 450.

In some examples, the monitoring server 460 may route alert data received from the network module 414 or the one or more user devices 440 and 450 to the central alarm station server 470. For example, the monitoring server 460 may transmit the alert data to the central alarm station server 470 over the network 405.

The monitoring server 460 may store sensor and image data received from the monitoring system and perform analysis of sensor and image data received from the monitoring system. Based on the analysis, the monitoring server 460 may communicate with and control aspects of the control unit 410 or the one or more user devices 440 and 450.

The monitoring server 460 may provide various monitoring services to the system 400. For example, the monitoring server 460 may analyze the sensor, image, and other data to determine an activity pattern of a resident of the home monitored by the system 400. In some implementations, the monitoring server 460 may analyze the data for alarm conditions or may determine and perform actions at the home by issuing commands to one or more of the controls 422, possibly through the control unit 410.

The monitoring server 460 can be configured to provide information (e.g., activity patterns) related to one or more residents of the home monitored by the system 400. For example, one or more of the sensors 420, the home automation controls 422, the camera 430, the thermostat 434, and the integrated security devices 480 can collect data related to a resident including location information (e.g., if the resident is home or is not home) and provide location information to the thermostat 434.

The central alarm station server 470 is an electronic device configured to provide alarm monitoring service by exchanging communications with the control unit 410, the one or more user devices 440 and 450, and the monitoring server 460 over the network 405. For example, the central alarm station server 470 may be configured to monitor alerting events generated by the control unit 410. In this example, the central alarm station server 470 may exchange communications with the network module 414 included in the control unit 410 to receive information regarding alerting events detected by the control unit 410. The central alarm station server 470 also may receive information regarding alerting events from the one or more user devices 440 and 450 and/or the monitoring server 460.

The central alarm station server 470 is connected to multiple terminals 472 and 474. The terminals 472 and 474 may be used by operators to process alerting events. For example, the central alarm station server 470 may route alerting data to the terminals 472 and 474 to enable an operator to process the alerting data. The terminals 472 and 474 may include general-purpose computers (e.g., desktop personal computers, workstations, or laptop computers) that are configured to receive alerting data from a server in the central alarm station server 470 and render a display of information based on the alerting data. For instance, the controller 412 may control the network module 414 to transmit, to the central alarm station server 470, alerting data indicating that a sensor 420 detected motion from a motion sensor via the sensors 420. The central alarm station server 470 may receive the alerting data and route the alerting data to the terminal 472 for processing by an operator associated with the terminal 472. The terminal 472 may render a display to the operator that includes information associated with the alerting event (e.g., the lock sensor data, the motion sensor data, the contact sensor data, etc.) and the operator may handle the alerting event based on the displayed information.

In some implementations, the terminals 472 and 474 may be mobile devices or devices designed for a specific function. Although FIG. 4 illustrates two terminals for brevity, actual implementations may include more (and, perhaps, many more) terminals.

The one or more authorized user devices 440 and 450 are devices that host and display user interfaces. For instance, the user device 440 is a mobile device that hosts or runs one or more native applications (e.g., the home monitoring application 442). The user device 440 may be a cellular phone or a non-cellular locally networked device with a display. The user device 440 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 440 may perform functions unrelated to the monitoring system, such as placing personal telephone calls, playing music, playing video, displaying pictures, browsing the Internet, maintaining an electronic calendar, etc.

The user device 440 includes a home monitoring application 452. The home monitoring application 442 refers to a software/firmware program running on the corresponding mobile device that enables the user interface and features described throughout. The user device 440 may load or install the home monitoring application 442 based on data received over a network or data received from local media. The home monitoring application 442 runs on mobile devices platforms, such as iPhone, iPod touch, Blackberry, Google Android, Windows Mobile, etc. The home monitoring application 442 enables the user device 440 to receive and process image and sensor data from the monitoring system.

The user device 440 may be a general-purpose computer (e.g., a desktop personal computer, a workstation, or a laptop computer) that is configured to communicate with the monitoring server 460 and/or the control unit 410 over the network 405. The user device 440 may be configured to display a smart home user interface 452 that is generated by the user device 440 or generated by the monitoring server 460. For example, the user device 440 may be configured to display a user interface (e.g., a web page) provided by the monitoring server 460 that enables a user to perceive images captured by the camera 430 and/or reports related to the monitoring system. Although FIG. 4 illustrates two user devices for brevity, actual implementations may include more (and, perhaps, many more) or fewer user devices.

In some implementations, the one or more user devices 440 and 450 communicate with and receive monitoring system data from the control unit 410 using the communication link 438. For instance, the one or more user devices 440 and 450 may communicate with the control unit 410 using various local wireless protocols such as Wi-Fi, Bluetooth, Z-wave, Zigbee, HomePlug (ethernet over power line), or wired protocols such as Ethernet and USB, to connect the one or more user devices 440 and 450 to local security and automation equipment. The one or more user devices 440 and 450 may connect locally to the monitoring system and its sensors and other devices. The local connection may improve the speed of status and control communications because communicating through the network 405 with a remote server (e.g., the monitoring server 460) may be significantly slower.

Although the one or more user devices 440 and 450 are shown as communicating with the control unit 410, the one or more user devices 440 and 450 may communicate directly with the sensors and other devices controlled by the control unit 410. In some implementations, the one or more user devices 440 and 450 replace the control unit 410 and perform the functions of the control unit 410 for local monitoring and long range/offsite communication.

In other implementations, the one or more user devices 440 and 450 receive monitoring system data captured by the control unit 410 through the network 405. The one or more user devices 440, 450 may receive the data from the control unit 410 through the network 405 or the monitoring server 460 may relay data received from the control unit 410 to the one or more user devices 440 and 450 through the network 405. In this regard, the monitoring server 460 may facilitate communication between the one or more user devices 440 and 450 and the monitoring system.

In some implementations, the one or more user devices 440 and 450 may be configured to switch whether the one or more user devices 440 and 450 communicate with the control unit 410 directly (e.g., through link 438) or through the monitoring server 460 (e.g., through network 405) based on a location of the one or more user devices 440 and 450. For instance, when the one or more user devices 440 and 450 are located close to the control unit 410 and in range to communicate directly with the control unit 410, the one or more user devices 440 and 450 use direct communication. When the one or more user devices 440 and 450 are located far from the control unit 410 and not in range to communicate directly with the control unit 410, the one or more user devices 440 and 450 use communication through the monitoring server 460.

Although the one or more user devices 440 and 450 are shown as being connected to the network 405, in some implementations, the one or more user devices 440 and 450 are not connected to the network 405. In these implementations, the one or more user devices 440 and 450 communicate directly with one or more of the monitoring system components and no network (e.g., Internet) connection or reliance on remote servers is needed.

In some implementations, the one or more user devices 440 and 450 are used in conjunction with only local sensors and/or local devices in a house. In these implementations, the system 400 includes the one or more user devices 440 and 450, the sensors 420, the home automation controls 422, the camera 430, and the robotic devices 490. The one or more user devices 440 and 450 receive data directly from the sensors 420, the home automation controls 422, the camera 430, and the robotic devices 490, and sends data directly to the sensors 420, the home automation controls 422, the camera 430, and the robotic devices 490. The one or more user devices 440, 450 provide the appropriate interfaces/processing to provide visual surveillance and reporting.

In other implementations, the system 400 further includes network 405 and the sensors 420, the home automation controls 422, the camera 430, the thermostat 434, and the robotic devices 490, and are configured to communicate sensor and image data to the one or more user devices 440 and 450 over network 405 (e.g., the Internet, cellular network, etc.). In yet another implementation, the sensors 420, the home automation controls 422, the camera 430, the thermostat 434, and the robotic devices 490 (or a component, such as a bridge/router) are intelligent enough to change the communication pathway from a direct local pathway when the one or more user devices 440 and 450 are in close physical proximity to the sensors 420, the home automation controls 422, the camera 430, the thermostat 434, and the robotic devices 490 to a pathway over network 405 when the one or more user devices 440 and 450 are farther from the sensors 420, the home automation controls 422, the camera 430, the thermostat 434, and the robotic devices 490.

In some examples, the system leverages GPS information from the one or more user devices 440 and 450 to determine whether the one or more user devices 440 and 450 are close enough to the sensors 420, the home automation controls 422, the camera 430, the thermostat 434, and the robotic devices 490 to use the direct local pathway or whether the one or more user devices 440 and 450 are far enough from the sensors 420, the home automation controls 422, the camera 430, the thermostat 434, and the robotic devices 490 that the pathway over network 405 is required.

In other examples, the system leverages status communications (e.g., pinging) between the one or more user devices 440 and 450 and the sensors 420, the home automation controls 422, the camera 430, the thermostat 434, and the robotic devices 490 to determine whether communication using the direct local pathway is possible. If communication using the direct local pathway is possible, the one or more user devices 440 and 450 communicate with the sensors 420, the home automation controls 422, the camera 430, the thermostat 434, and the robotic devices 490 using the direct local pathway. If communication using the direct local pathway is not possible, the one or more user devices 440 and 450 communicate with the sensors 420, the home automation controls 422, the camera 430, the thermostat 434, and the robotic devices 490 using the pathway over network 405.

In some implementations, the system 400 provides end users with access to images captured by the camera 430 to aid in decision making. The system 400 may transmit the images captured by the camera 430 over a wireless WAN network to the user devices 440 and 450. Because transmission over a wireless WAN network may be relatively expensive, the system 400 can use several techniques to reduce costs while providing access to significant levels of useful visual information (e.g., compressing data, down-sampling data, sending data only over inexpensive LAN connections, or other techniques).

In some implementations, a state of the monitoring system and other events sensed by the monitoring system may be used to enable/disable video/image recording devices (e.g., the camera 430). In these implementations, the camera 430 may be set to capture images on a periodic basis when the alarm system is armed in an “away” state, but set not to capture images when the alarm system is armed in a “home” state or disarmed. In addition, the camera 430 may be triggered to begin capturing images when the alarm system detects an event, such as an alarm event, a door-opening event for a door that leads to an area within a field of view of the camera 430, or motion in the area within the field of view of the camera 430. In other implementations, the camera 430 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device.

Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device.

Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A computer-implemented method comprising:
obtaining, using one or more imaging devices, images of an outside area corresponding to a property, wherein the images are captured by one or more cameras (i) of the one or more imaging devices or (ii) electronically connected to the one or more imaging devices;
determining, from the images, that a person is approaching the property or has entered the property;
identifying a state of the property;
based on the images and the state of the property, determining an action to perform by a drone; and
instructing the drone to:
navigate to a location corresponding to the person; and
perform the action.

2. The method of claim 1, wherein identifying the state of the property comprises determining whether any occupants of the property are located at the property,
wherein determining the action to perform by the drone comprises determining the action based on whether any occupants of the property are located at the property.

3. The method of claim 2, wherein:
determining whether any occupants of the property are located at the property comprises determining that one or more occupants of the property are located at the property;
identifying the state of the property comprises determining one or more locations of the one or more occupants at the property; and
determining the action to perform by the drone comprises determining the action based on the one or more locations of the one or more occupants.

4. The method of claim 3, wherein determining the action based on the one or more locations of the one or more occupants comprises:
based on the one or more locations of the one or more occupants, selecting a location of the one or more locations corresponding to an occupant of the one or more occupants; and
determining that the drone is to guide the person to the location of the occupant.

5. The method of claim 4, wherein determining that the drone is to guide the person to the location of the occupant comprises determining that drone is to guide the person instead of performing one or more other actions in response to at least one of the following:
based on the images, identifying the person as a previously identified person;
based on the images, identifying the person as a visitor of the property;
determining that the one or more occupants of the property include an adult occupant and that the occupant is an adult occupant;
determining that the location of the occupant is a location in a particular area of the property where permission settings for the property indicate that at least one person is permitted to approach or enter the particular area of the property; and
determining that a current time coincides with a set time range (i) for a scheduled event, (ii) when control settings provide that at least one person is permitted to approach or enter the property, or (iii) between sunrise and sunset of a geographic location of the property.

6. The method of claim 5, wherein the one or more other actions include at least one of the following:
tracking the person using an onboard camera of the drone while the person approaches the property or remains on the property;
opening a line of communication between the drone and a device of the occupant; and
generating and wirelessly transmitting a notification to a device of the occupant or to an external computing system.

7. The method of claim 2, wherein:
determining whether any occupants of the property are located at the property comprises determining that one or more occupants of the property are located at the property;
identifying the state of the property comprises determining one or more identities of the one or more occupants; and
determining the action to perform by the drone comprises determining the action based on the one or more identities of the one or more occupants.

8. The method of claim 7, wherein determining the action based on the one or more identities of the one or more occupants comprises:
based on the one or more identities, selecting an occupant of the one or more occupants located at the property; and
determining that the drone is to guide the person to the location of the occupant based on the identity of the occupant.

9. The method of claim 8, wherein selecting the occupant of the one or more occupants located at the property comprises selecting the occupant from the one or more occupants based on at least one of the following:
the occupant of the one or more occupants is an adult where at least one other occupant of the one or more occupants is a child;
the occupant of the one or more occupants is permanent occupant of the property where at least one other occupant of the one or more occupants is a temporary occupant; and
control settings indicates that the occupant of the one or more occupants is preferred to make contact with the person or with all persons over at least one other occupant of the one or more occupants.

10. The method of claim 1, wherein identifying the state of the property comprises determining a time or date,
wherein determining the action to perform by the drone comprises determining the action based on the time or date.

11. The method of claim 10, wherein determining the action based on the time or date comprises determining that the drone is to:
track the person;
generate a notification if the person enters the property or remains on the property; and
wirelessly transmit the notification to at least one occupant of the property or an external system.

12. The method of claim 11, wherein determining that the drone is to track the person comprises:
based on the images, determining that the person is not an occupant of the property; and
determining to track the person in response to a determination that (i) a current time or date corresponds to a set time or date when visitors are not permitted to enter the property or (ii) the current time or date does not intersect one or more time ranges when visitors are permitted to enter the property.

13. The method of claim 1, wherein:
determining the action comprises determining to communicate with the person by the drone using communication parameters selected based on at least one of the state of the property and the images; and
instructing the drone to perform the action comprises instructing the drone to communicate with the person using the communication parameters.

14. The method of claim 1, wherein:
identifying the state of the property comprises using the images to determine an identity of the person; and
determining the action to perform by the drone comprises determining an action to perform by the drone based on the identity of the person.

15. The method claim 1, wherein:
identifying the state of the property comprises using the images to determine that the person is a newly identified person; and
determining the action to perform by the drone comprises determining instructions to have the drone track the person until they leave the property or change trajectory so that their new trajectory does not intersect at least a portion of the property.

16. The method of claim 1, wherein:
the one or more imaging devices comprise a smart doorbell installed on the property at a position having a viewpoint of the outside area;
the one or more cameras comprise a doorbell camera (i) of the smart doorbell or (ii) electronically connected to the smart doorbell; and
obtaining the images comprises using the doorbell camera to capture at least a subset of the images of the outside area.

17. The method of claim 1, wherein obtaining the images comprises:
based on the state of the property, determining one or more triggering events;
detecting a triggering event of the one or more triggering events; and
in response to detecting the triggering event, obtaining the images using the one or more imaging devices.

18. The method of claim 1, wherein obtaining the images comprises:
based on the state of the property, activating the one or more imaging devices; and
after activating the one or more imaging devices, obtaining the images using the one or more imaging devices.

19. A system comprising:
one or more computers; and
one or more computer-readable media storing instructions that, when executed, cause the one or more computers to perform operations comprising:
obtaining, using one or more imaging devices, images of an outside area corresponding to a property, wherein the images are captured by one or more cameras (i) of the one or more imaging devices or (ii) electronically connected to the one or more imaging devices;
determining, from the images, that a person is approaching the property or has entered the property;
identifying a state of the property;
based on the images and the state of the property, determining an action to perform by a drone; and
instructing the drone to:
navigate to a location corresponding to the person; and
perform the action.

20. One or more non-transitory computer-readable media storing instructions that, when executed by one or more computers, cause the one or more computers to perform operations comprising:
obtaining, using one or more imaging devices, images of an outside area corresponding to a property, wherein the images are captured by one or more cameras (i) of the one or more imaging devices or (ii) electronically connected to the one or more imaging devices;
determining, from the images, that a person is approaching the property or has entered the property;
identifying a state of the property;
based on the images and the state of the property, determining an action to perform by a drone; and
instructing the drone to:
navigate to a location corresponding to the person; and
perform the action.
